(19) United States
(12) Patent Application Publication
(10) Pub. No.: US 2024/0265307 A1
(43) Pub. Date: Aug. 8, 2024

(54) MODEL TRAINING METHOD AND DEVICE

(71) Applicants: BEIJING XIAOMI MOBILE SOFTWARE CO., LTD., Beijing (CN); BEIJING UNIVERSITY OF POSTS AND TELECOMMUNICATIONS, Beijing (CN)

(72) Inventors: Qin MU, Beijing (CN); Wei HONG, Beijing (CN); Zhongyuan ZHAO, Beijing (CN); Jingyi WANG, Beijing (CN)

(73) Assignee: BEIJING XIAOMI MOBILE SOFTWARE CO., LTD., Beijing (CN)

(21) Appl. No.: 18/566,626

(22) PCT Filed: Jun. 2, 2021
(86) PCT No.: PCT/CN2021/098008

§ 371 Date: Dec. 1, 2023

(51) Int. Cl. G06N 20/00; H04L 41/16

(52) U.S. Cl. CPC G06N 20/00; H04L 41/16

(57) ABSTRACT

A model training method and device are provided. The method is applied to an OAM entity and includes: obtaining at least one wireless access network device group by grouping a plurality of wireless access network devices sending model subscription requests, the wireless access network device group including a first number of wireless access network devices; determining a first number of model training structures corresponding to the first number of wireless access network devices, and determining a first number of unique model layers according to the first number of model training structures; and sending, to the first number of wireless access network devices, structural parameters of the first number of unique model layers.

### CROSS-REFERENCE TO RELATED APPLICATIONS

The present application is a U.S. National Stage of International Application No. PCT/CN2021/098008 filed on Jun. 2, 2021, the entire contents of which are incorporated herein by reference for all purposes.

### TECHNICAL FIELD

The present disclosure relates to the field of wireless communication technology, and in particular, to a model training method, a model training device, and a storage medium.

### BACKGROUND

The wireless network AI architecture provides the basis for implementing wireless AI. In addition, according to the scenario where the terminal has high-speed mobility, the wireless network AI architecture is standardized and optimized to ensure the coherence of model training and model inference, the continuity of AI analysis service for a terminal, and the mobility management of wireless AI. In the 3rd Generation Partnership Project (3GPP) conference, a wireless network architecture supporting AI is proposed so as to obtain a big data-enabled AI wireless network.

The wireless network architecture supporting AI can handle a plurality of training task scenarios simultaneously. However, individual model training is required for each training task, resulting in relatively large training overheads as well as reduced data securities.

### SUMMARY

The present disclosure provides a model training method, a model training device, and a storage medium.

A first aspect of embodiments of the present disclosure provides a model training method applied to an operation administration and maintenance (OAM) entity, including:

obtaining at least one wireless access network device group by grouping a plurality of wireless access network devices sending model subscription requests, the wireless access network device group including a first number of wireless access network devices; determining a first number of model training structures corresponding to the first number of wireless access network devices, and determining a first number of unique model layers according to the first number of model training structures; and sending, to the first number of wireless access network devices, structural parameters of the first number of unique model layers.

In an implementation, determining the first number of model training structures corresponding to the first number of wireless access network devices includes:

determining a first number of model subscription requests sent by the first number of wireless access network devices, and determining model training task characteristics of the first number of model subscription requests, the model training task characteristic being configured to indicate a number of layers and a number of nodes of a model; and determining the first number of model training structures according to the number of layers and the number of nodes of the model indicated by the model training task characteristics.

In an implementation, determining the first number of unique model layers according to the first number of model training structures includes:

determining output layers of the first number of model training structures corresponding to the first number of wireless access network devices as the first number of unique model layers.

In an implementation, the model training method further includes:

determining input layers and hidden layers of the model training structures corresponding to the first number of radio access network devices as shared model layers, obtaining data of the plurality of radio access network devices, and adding, to the data, datum identifiers corresponding to respective radio access network devices; obtaining model training data and model label values by classifying and processing all the data with the datum identifiers; obtaining first output data output by the shared model layers by inputting the model training data as first input data to the shared model layers; and sending the model label values and the first output data to the plurality of wireless access network devices.

In an implementation, the model training method further includes:

updating, in response to receiving training loss values from the plurality of wireless access network devices, structural parameters of the shared model layers according to the training loss values.

In an implementation, updating the shared model layers according to the training loss values includes:

obtaining weighted loss values by weighting the training loss values; determining current model parameters and current model learning rates of the shared model layers; and determining update parameters of the shared model layers according to the weighted loss values, the model parameters and the model learning rates, and updating the structural parameters of the shared model layers according to the update parameters.

In an implementation, the model training method further includes, after updating the shared model layers according to the update parameters:

determining, in response to a T^{th} update of the structural parameters of the shared model layers, that training of the shared model layers is complete, sending the model structural parameters of the shared model layers obtained after the T^{th} update, to each wireless access network device in the plurality of wireless access network device groups, wherein T is a predetermined number of times to update the shared model layers and the unique model layers, and the structural parameters of the shared model layers are configured for the wireless access network devices to synthesize a model to which the wireless access network device subscribes.

In an implementation, obtaining the at least one wireless access network device group by grouping the plurality of wireless access network devices sending the model subscription requests includes:

determining a type of subscription model included in each of the model subscription requests; obtaining a first number of model subscription request groups by grouping the model subscription requests according to the type of the subscription model; and obtaining the first number of wireless access network device groups by grouping the wireless access network devices.

In an implementation, the model training method further includes:

in response to that there is a newly-joined wireless access network device and the newly-joined wireless access network device satisfies a model training condition, sending the structural parameter of the unique model layer corresponding to the newly-joined wireless access network device to the newly-joined wireless access network device; or re-determining the first number of model training structures in response to that there is an exiting wireless access network device.

A second aspect of embodiments of the present disclosure provides a model training method applied to a wireless access network device, including:

receiving a structural parameter of a unique model layer sent by an OAM, wherein the unique model layer is determined by the OAM dividing a first number of model training structures, the first number of model training structures are determined by the OAM according to model subscription requests of a first number of wireless access network devices included in a wireless access network device group.

In an implementation, the model training method further includes:

receiving model label values and first output data sent by the OAM; obtaining second output data output by the unique model layer by using the first output data as input to the unique model layer and inputting the first output data to the unique model layer; and determining a training loss value according to the model label value and the second output data, and sending the training loss value to the OAM.

In an implementation, determining the training loss value according to the model training data and the second output data includes:

determining, among the model label values, the model label value corresponding to the wireless access network device according to identifiers carried by the model training data; and determining the training loss value by performing an operation on the second output data and the training label value, and updating the structural parameter of the unique model layer according to the training loss value.

In an implementation, the model training method further includes:

receiving a structural parameter of a shared model layer sent by the OAM; and determining a structural parameter of a subscription model according to the structural parameter of the shared model layer and the structural parameter of the unique model layer after a T^{th} update, wherein T is a predetermined number of times to update the shared model layer and the unique model layer.

A third aspect of embodiments of the present disclosure provides a model training device applied to an operation administration and maintenance (OAM) entity, including: a grouping module, configured to obtain at least one wireless access network device group by grouping a plurality of wireless access network devices sending model subscription requests, the wireless access network device group including a first number of wireless access network devices; a determining module, configured to determine a first number of model training structures corresponding to the first number of wireless access network devices, and determine a first number of unique model layers according to the first number of model training structures; and a sending module, configured to send, to the first number of wireless access network devices, structural parameters of the first number of unique model layers.

In an implementation, the determining module is configured to:

determine a first number of model subscription requests sent by the first number of wireless access network devices, and determine model training task characteristics of the first number of model subscription requests, the model training task characteristic being configured to indicate a number of layers and a number of nodes of a model; and determine the first number of model training structures according to the number of layers and the number of nodes of the model indicated by the model training task characteristics.

In an implementation, the determining module is configured to:

determine output layers of the first number of model training structures corresponding to the first number of wireless access network devices as the first number of unique model layers.

In an implementation, the determining module is further configured to:

determine input layers and hidden layers of the model training structures corresponding to the first number of radio access network devices as shared model layers, obtaining data of the plurality of radio access network devices, and adding, to the data, datum identifiers corresponding to respective radio access network devices; obtain model training data and model label values by classifying and processing all the data with the datum identifiers; obtain first output data output by the shared model layers by inputting the model training data as first input data to the shared model layers; and send the model label values and the first output data to the plurality of wireless access network devices.

In an implementation, the model training device further includes an updating module, configured to:

update, in response to receiving training loss values from the plurality of wireless access network devices, structural parameters of the shared model layers according to the training loss values.

In an implementation, the updating module is configured to:

obtain weighted loss values by weighting the training loss values; determining current model parameters and current model learning rates of the shared model layers; and determining update parameters of the shared model layers according to the weighted loss values, the model parameters and the model learning rates, and updating the structural parameters of the shared model layers according to the update parameters.

In an implementation, the updating module is configured to:

determine, in response to a T^{th} update of the structural parameters of the shared model layers, that training of the shared model layers is complete, and send the model structural parameters of the shared model layers obtained after the T^{th} update, to each wireless access network device in the plurality of wireless access network device groups, wherein T is a predetermined number of times to update the shared model layers and the unique model layers, and the structural parameters of the shared model layers are configured for the wireless access network devices to synthesize a model to which the wireless access network device subscribes.

In an implementation, the grouping module is configured to:

determine a type of subscription model included in each of the model subscription requests; obtain a first number of model subscription request groups by grouping the model subscription requests according to the type of the subscription model; and obtain the first number of wireless access network device groups by grouping the wireless access network devices.

In an implementation, the updating module is further configured to:

in response to that there is a newly-joined wireless access network device and the newly-joined wireless access network device satisfies a model training condition, send the structural parameter of the unique model layer corresponding to the newly-joined wireless access network device to the newly-joined wireless access network device; or re-determine the first number of model training structures in response to that there is an exiting wireless access network device.

A fourth aspect of embodiments of the present disclosure provides a model training device applied to a wireless access network device, including:

a receiving module, configured to receive a structural parameter of a unique model layer sent by an OAM, wherein the unique model layer is determined by the OAM dividing a first number of model training structures, the first number of model training structures are determined by the OAM according to model subscription requests of a first number of wireless access network devices included in a wireless access network device group.

In an implementation, the receiving module is further configured to:

receive model label values and first output data sent by the OAM; obtain second output data output by the unique model layer by using the first output data as input to the unique model layer and inputting the first output data to the unique model layer; and determine a training loss value according to the model label value and the second output data, and send the training loss value to the OAM.

In an implementation, the model training device further includes a determining module, configured to:

determine, among the model label values, the model label value corresponding to the wireless access network device according to identifiers carried by the model training data; and determine the training loss value by performing an operation on the second output data and the training label value, and updating the structural parameter of the unique model layer according to the training loss value.

In an implementation, the receiving module is further configured to:

receive a structural parameter of a shared model layer sent by the OAM; and determine a structural parameter of a subscription model according to the structural parameter of the shared model layer and the structural parameter of the unique model layer after a T^{th} update, wherein T is a predetermined number of times to update the shared model layer and the unique model layer.

A fifth aspect of embodiments of the present disclosure provides a model training device, including:

a processor and a memory for storing instructions that are executable by the processor, wherein the processor is configured to perform the model training method according to the first aspect or any implementation of the first aspect, or the model training method according to the second aspect or any implementation of the second aspect.

A sixth aspect of embodiments of the present disclosure provides a non-transitory computer-readable storage medium having instructions stored thereon that, when being executed by a processor of a mobile terminal, cause the mobile terminal to perform the model training method according to the first aspect or any implementation of the first aspect, or the model training method according to the second aspect or any implementation of the second aspect.

It should be understood that the above general description and the following detailed descriptions are exemplary and explanatory only and do not limit the embodiments of the present disclosure.

### BRIEF DESCRIPTION OF THE DRAWINGS

The accompanying drawings herein, which are incorporated into and form a part of the specification, illustrate embodiments consistent with the present disclosure and are used in conjunction with the specification to explain the principle of the present disclosure.

FIG. 1 is a schematic diagram of a wireless network architecture supporting artificial intelligence according to an embodiment.

FIG. 2 is a schematic diagram of a multi-task model training task according to an embodiment.

FIG. 3 is a schematic diagram of another multi-task model training task according to an embodiment.

FIG. 4 is a schematic diagram of a system architecture of a model training method according to an embodiment.

FIG. 5 is a flowchart of another model training method according to an embodiment.

FIG. 6 is a flowchart of another model training method according to an embodiment.

FIG. 7 is a flowchart of training a model structure in a model training method according to an embodiment.

FIG. 8 is a flow diagram of another model training method according to an embodiment.

FIG. 9 is a flowchart of another model training method according to an embodiment.

FIG. 10 is a flowchart of a process for collecting and identifying model training data for a training model structure according to an embodiment.

FIG. 11 is a flowchart of another model training method according to an embodiment.

FIG. 12 is a flowchart of another model training method according to an embodiment.

FIG. 13 is a flowchart of another model training method according to an embodiment.

FIG. 14 is a flowchart of another model training method according to an embodiment.

FIG. 15 is a flowchart of another model training method according to an embodiment.

FIG. 16 is a flowchart of adding a wireless access network device in a model training method according to an embodiment.

FIG. 17 is a flowchart of a model training method according to an embodiment.

FIG. 18 is a flowchart of a wireless access network device exiting in a model training method according to an embodiment.

FIG. 19 is a flowchart of another model training method according to an embodiment.

FIG. 20 is a flowchart of another model training method according to an embodiment.

FIG. 21 is a flowchart of another model training method according to an embodiment.

FIG. 22 is a flowchart of updating a unique model layer parameter of a model training method according to an embodiment.

FIG. 23 is a flowchart of another model training method according to an embodiment.

FIG. 24 is a schematic diagram of model training and model inference of a model training method according to an embodiment.

FIG. 25 is a flowchart of a model training method and a model inference method according to an embodiment.

FIG. 26 is a schematic diagram of protocol and interface for model training of a model training method according to an embodiment.

FIG. 27 is a schematic diagram of protocol and interface for model inference of a model training method according to an embodiment.

FIG. 28 is a schematic diagram of protocol and interface for model training data collection for a model training method according to an embodiment.

FIG. 29 is a schematic diagram of protocol and interface for model inference data collection of a model training method according to an embodiment.

FIG. 30 is a block diagram of a model training device according to an embodiment.

FIG. 31 is a block diagram of another model training device according to an embodiment.

FIG. 32 is a block diagram of a device for model training according to an embodiment.

FIG. 33 is a block diagram of another device for model training according to an embodiment.

### DETAILED DESCRIPTION

Exemplary embodiments will be described herein in detail, examples of which are represented in the accompanying drawings. When the following description relates to the accompanying drawings, the same numerals in the different accompanying drawings indicate the same or similar elements unless otherwise indicated. The implementations described in the following embodiments do not represent all implementations consistent with the present disclosure. Rather, they are only examples of devices and methods consistent with some aspects of the present disclosure.

The wireless network AI architecture provides the basis for implementing wireless AI. In addition, according to the scenario where the terminal has high-speed mobility, the wireless network AI architecture is standardized and optimized to ensure the coherence of model training and model inference, the continuity of AI analysis service for a terminal, and the mobility management of wireless AI. In the 3rd Generation Partnership Project (3GPP) conference, a wireless network architecture supporting AI is proposed so as to obtain a big data-enabled AI wireless network.

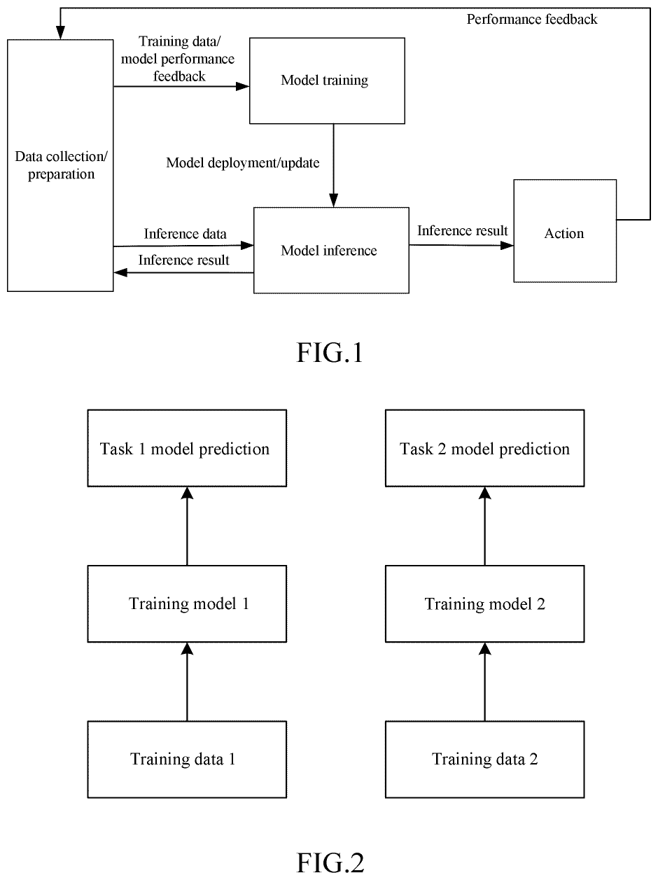

FIG. 1 is a schematic diagram of a wireless network architecture supporting artificial intelligence (AI) according to an embodiment. As shown in FIG. 1, the wireless network architecture supporting AI includes a data collection/preparation unit, a model training unit, a model inference unit, an action unit, training data, model performance feedback, model deployment/update, inference data, inference result, and performance feedback.

The data collection/preparation unit collects data related to AI model training, updating, and inference, and pre-processes the data according to the requirements of AI model training, updating, and inference on data content, size, format, and period, and provides the processed data to the model training unit and the model prediction unit according to requirements. In addition, the data collection/preparation unit may also determine the effectiveness of the current AI model based on the collected data and provide model performance feedback to the model training unit.

The model training unit is responsible for the training and updating of the AI model, the input data required for training and updating is provided by the data collection/preparation unit, and the model training unit provides the trained or updated AI model to the model inference unit.

The model inference unit performs a specific wireless network inference task based on the AI model provided by the model training unit and the input data provided by the data collection/preparation unit, and provides the inference result to the action unit and the data collection/preparation unit.

The action unit performs a corresponding network action based on the inference result provided by the model inference unit, and the action unit will collect data from the network side and provides the same to the data collection/preparation unit in the form of performance feedback.

As for the training data, the data collection/preparation unit pre-processes the collected data and provides the data needed for AI model training and updating to the model training unit.

As for the model performance feedback, the data collection/preparation unit determines the effectiveness of the current AI model based on the collected data (e.g., comparing the predicted data with the actual measured data) and provides the model performance feedback to the model training unit.

As for the model deployment/update, the model training unit provides the trained and updated AI model to the model inference unit.

As for the inference data, the data collection/preparation unit pre-processes the collected data and provides the data needed for AI model inference to the model inference unit.

As for the inference result, the inference result generated according to the AI model is provided by the model inference unit to the action unit and the data collection/preparation unit.

As for the performance feedback, after executing the corresponding network action, the action unit collects data from the network side and provides the same to the data collection/preparation unit.

In the related art, when the operation administration and maintenance (OAM) receives a plurality of training model requests, it needs to perform model training for each model training task individually, and different training tasks are independent of each other. FIG. 2 is a schematic diagram of a multi-task model training task according to an embodiment. As shown in FIG. 2, based on the determined two model subscription requests, it first determines that two training data includes training data 1 and training data 2, a model 1 is trained based on the training data 1, a model 2 is trained based on the training data 2, and thus a task 1 model prediction and a model 2 task prediction are obtained. In this process, model information is not shared between different training tasks.

It will be further illustrated by taking that a single model is trained and the radio access network device is a 5G base station as an example. A terminal initiates a model subscription request to a 5G base station distributed unit radio access network device (next Generation Node B Distributed Unit, gNB-DU), the gNB-DU sends the model subscription request of the terminal to a 5G base station control unit (next Generation Node B Control Unit, gNB-CU), and the gNB-CU reports the model subscription request of the terminal to the OAM. The OAM selects a suitable training model based on the model subscription request of the terminal, and collects the model training data for model training. After the model training is completed, the OAM sends the training model to the gNB-CU, the gNB-CU collects the model inference data for model inference. After the model inference is completed, the gNB-CU sends the inference model to the gNB-DU, the gNB-DU sends the inference model to the terminal, and the terminal executes a corresponding policy according to the inference model.

Based on the manner of training the model of the above embodiments, it can be seen that in the related art, there are the following technical problems.
(1) The model training and model inference are performed with respect to the model subscription request from a single terminal, and finally the inference result is sent to the terminal, however a model is trained for each training task, which causes a large training overhead and does not sufficiently consider the differences and connections of these training tasks.
(2) In the process of model training, the OAM needs the gNB-CU to upload data to the OAM, which reduces data security. If a portion of the model training work is transferred to the gNB-CU, the amount of uploaded data may be reduced, and the data security risk may be reduced.
(3) The model training work is all finished by the OAM, which will consume more computing resources of the OAM. If a portion of the model training work is transferred to the gNB-CU, it will be conducive to a balanced allocation of resources.

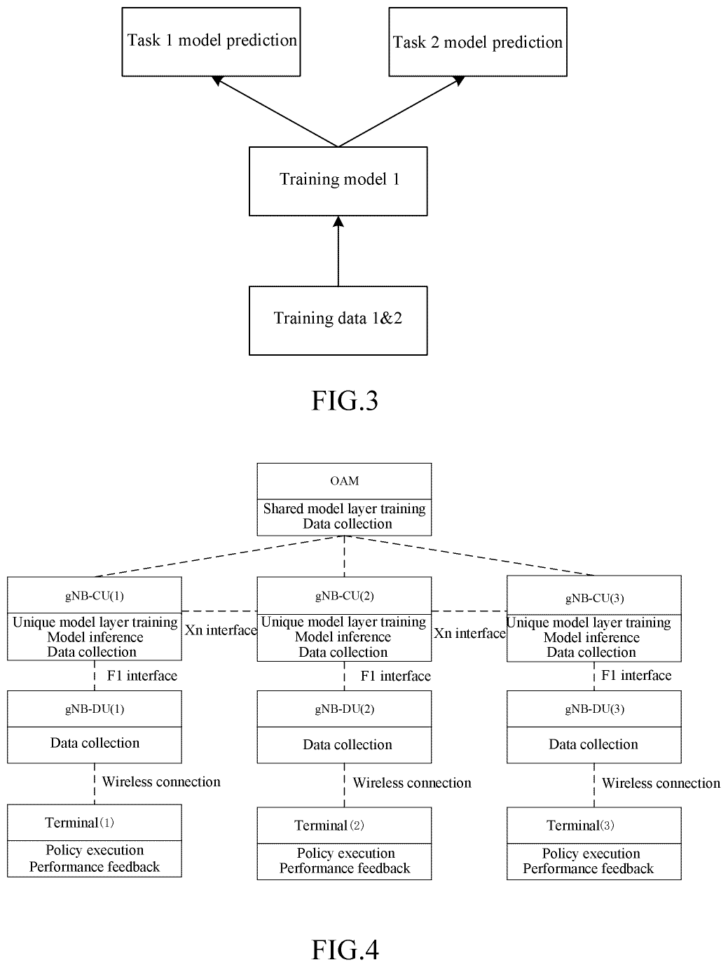

In view of the above, the present disclosure provides a model training method. FIG. 3 is a schematic diagram of a multi-task model training task according to an embodiment. As shown in FIG. 3, based on two determined model subscription requests, two training data including training data 1 and training data 2 are first determined, where the training data 1 and the training data 2 are in the same training data set. A task 1 model prediction and a task 2 model prediction are determined by training a model based on the training data 1 and the training data 2.

Further, when the OAM receives the plurality of model subscription requests, the model training tasks are assigned to the OAM and the radio access network device. The OAM side maintains a shared model layer shared by all gNB-CUs, which is used for feature extraction of the model training data, and the gNB-CU side maintains a unique model layer unique to the gNB-CU, which is used for outputting the model result. The output data of the shared model layer is used as the input of the unique model layer. After the gNB-CU updates the structural parameter of the unique model layer based on the local training loss value, the OAM then updates the structural parameter of the shared model layer based on the training loss value sent by the gNB-CU. The collaborative training method not only increases the generalization ability of the training model, improves the user service experience, and guarantees the effectiveness of the AI analysis service of the wireless network, but also reduces the model training overhead, which is conducive to improving the operation efficiency of the wireless network.

It can be further understood that the wireless communication system according to an embodiment of the present disclosure is a network that provides wireless communication functions. The wireless communication system may use different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance. According to the capacity, rate, latency, and other factors of different networks, the network may be classified as a 2G (generation) network, a 3G network, a 4G network, or a future evolution network, such as a 5G network, which can also be referred to as a New Radio (NR) network. For ease of description, the wireless communication network may be referred to as network simply sometimes in the present disclosure.

Further, the network device involved in the present disclosure may also be referred to as a wireless access network device. The wireless access network device may be a base station, an evolved node B (base station), a home base station, and an access point (AP), a wireless relay node, a wireless backhaul node, a transmission point (TP) or a transmission and reception point (TRP) in a wireless fidelity (WIFI) system, it may further be a gNB in a NR system, or it may further be a component or a part of a device that constitutes a base station. In the vehicle to everything (V2X) communication system, the network device may also be an in-vehicle device. It should be understood that the embodiment of the present disclosure does not limit the specific technology and the specific device form used for the network device.

Further, the terminal involved in the present disclosure may also be referred to as a terminal device, user equipment (UE), mobile station (MS), mobile terminal (MT) or the like, which is a device that provides voice and/or data connectivity to a user, for example, the terminal may be a handheld device, an in-vehicle device or the like with a wireless connection function. Currently, some examples of the terminal are: a mobile phone, a pocket personal computer (PPC), a palm computer, a personal digital assistant (PDA), a laptop computer, a tablet computer, a wearable device, an in-vehicle device or the like. In the vehicle to everything (V2X) communication system, the terminal device may also be an in-vehicle device. It should be understood that the embodiment of the present disclosure does not limit the specific technology and the specific device form used for the terminal.

FIG. 4 is a schematic diagram of a system architecture of a model training method according to an embodiment. As shown in FIG. 4, the system includes a terminal, a wireless access network device (including a gNB-DU and a gNB-CU), and an OAM. The terminal accesses the gNB-DU through a wireless channel, a plurality of gNB-DUs accesses the gNB-CUs through an F1 interface, and the gNB-CUs are connected to each other through an Xn interface. The OAM mainly undertakes the work of model training functional unit and data collection/preparation functional unit in the wireless network architecture supporting AI, and is mainly responsible for sharing model training and data collection. The gNB-CU mainly undertakes the work of the model training functional unit, the data collection/preparation functional unit, and the model inference functional unit in the wireless network architecture supporting AI, and is mainly responsible for unique model training, model inference, and data collection. The gNB-DU mainly undertakes the work of the data collection/preparation functional unit in the wireless network architecture supporting AI, and is mainly responsible for data collection. The terminal mainly undertakes the work of the action execution functional unit in the wireless network architecture supporting AI, and is mainly responsible for policy execution and performance feedback.

Based on the above schematic diagram of the system architecture of the model training method, the present disclosure provides a model training method, and the following embodiments will illustrate the model training method in conjunction with the accompanying drawings.

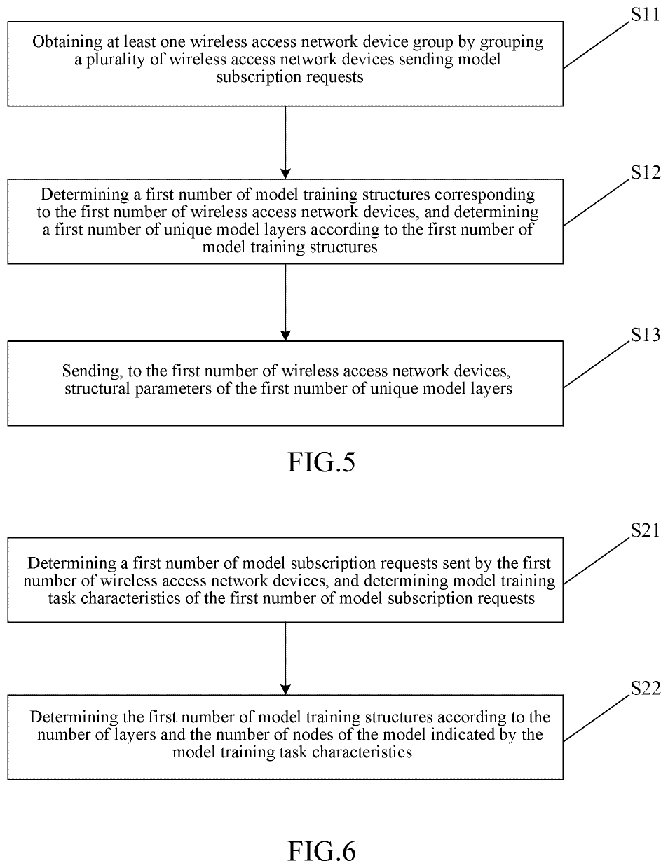

FIG. 5 is a flowchart of a model training method according to an embodiment. As shown in FIG. 5, the model training method is used in OAM and includes the following steps.

In step S11, at least one wireless access network device group is obtained by grouping a plurality of wireless access network devices sending model subscription requests.

The wireless access network device group includes a first number of wireless access network devices.

In an embodiment of the present disclosure, the OAM receives a plurality of model subscription requests sent by a plurality of wireless access network devices, and determines information such as a terminal identity, a model request type, an access location included in each model subscription request. The terminal identity is a Globally Unique Temporary UE Identity (GUTI). The model request type is represented by an analysis ID, such as load prediction analysis service. The access location information mainly includes information of gNB-CU and gNB-DU to which the terminal is currently accessing.

The OAM analyzes the similarity of models requested in the model request based on the above information, and groups the model subscription requests sent by different radio access network devices according to the similarity. For example, the subscription request analysis information from gNB-CU(n1) to gNB-CU(n2) shows that the terminal requests a model used for load prediction, and the subscription request analysis information from gNB-CU(n3) to gNB-CU(n4) shows that the terminal requests a model used for network decision. Based on the similarity between different training tasks, it may group gNB-CU (n1) to gNB-CU(n2) into one group for model training, and group gNB-CU(n3) to gNB-CU(n4) into another group for model training.

In step S12, a first number of model training structures corresponding to the first number of wireless access network devices is determined, and a first number of unique model layers is determined according to the first number of model training structures.

In an embodiment of the present disclosure, the OAM determines model training structures for each radio access network device group, i.e., determines a corresponding first number of model training structures for the first number of radio access network devices in each radio access network device group. The OAM divides the first number of model training structures into shared model layers and unique model layers. The OAM determines the unique model layer corresponding to each model training structure.

In step S13, structural parameters of the first number of unique model layers are sent to the first number of wireless access network devices.

In an embodiment of the present disclosure, the unique model layer corresponding to each model training structure determined is sent to a corresponding wireless access network device. By taking the wireless access device is gNB-CU as an example, the OAM sends the structural parameter information of the unique model layers to each gNB-CU in accordance with a mapping table from each gNB-CU to each connection manner, and each gNB-CU receives the model information and uses the unique model layer as a local model for model training and updating.

The model training method provided by the embodiments of the present disclosure may transfer a portion of the model training work to the wireless access network device, which may reduce the amount of uploaded data, be conducive to the balanced allocation of resources, and reduce data security risk.

FIG. 6 is a flowchart of a model training method according to an embodiment. As shown in FIG. 6, the model training method is used in OAM and includes the following steps.

In step S21, a first number of model subscription requests sent by the first number of wireless access network devices are determined, and model training task characteristics of the first number of model subscription requests are determined.

The model training task characteristic is configured to indicate a number of layers and a number of nodes of a model.

In an embodiment of the present disclosure, the model training tasks of the model subscription requests are different, and the number of layers and the number of nodes of the to-be-trained models corresponding to the requests are different. The model training task characteristic of each model subscription request may be determined based on the model training task. The number of nodes of the input layer is set to M, which represents the volume of training data that is input into the input model at one time. The number of nodes of the output layer is set to N, and N depends on the number of gNB-CUs and the training task characteristics. For example, each gNB-CU corresponds to one node in the prediction task (regression task), and each gNB-CU corresponds to a plurality of nodes in the decision task. The number of hidden layers is set to S, and the number of nodes per hidden layer is set to L. The number of hidden layers needs to take into account factors such as model size and model generalization ability. Therefore, the model training task characteristics are determined.

In step S22, the first number of model training structures are determined according to the number of layers and the number of nodes of the model indicated by the model training task characteristics.

In an embodiment of the present disclosure, the model training structure includes a connection manner between the model layers, i.e., the connection manner between the corresponding layers. it may use a full connection manner between the hidden layer and the input layer, and the activation function may use a ReLU function. It may use the full connection manner between the hidden layers, and the activation function may use the ReLU function. It may use a local connection manner between the hidden layer and the output layer, and the activation function may use a Softmax function or a Sigmoid function.

It should be noted that as for the process of determining a loss function to be used, the prediction task (regression task) may use the Mean Square Error (MSE) loss function, the Mean Absolute Error (MAE) loss function, the Huber loss function and the like, and the decision task (classification task) may use the cross-entropy loss function, the Hinge loss function, the logarithmic loss function and the like.

As for the process of determining the hyper-parameters of the network model, the learning rounds may be set to T, the learning rounds need to take into account the model training speed and training costs and the model training accuracy, and the learning rate is set to α and β. The weight initialization method selects random weight initialization.

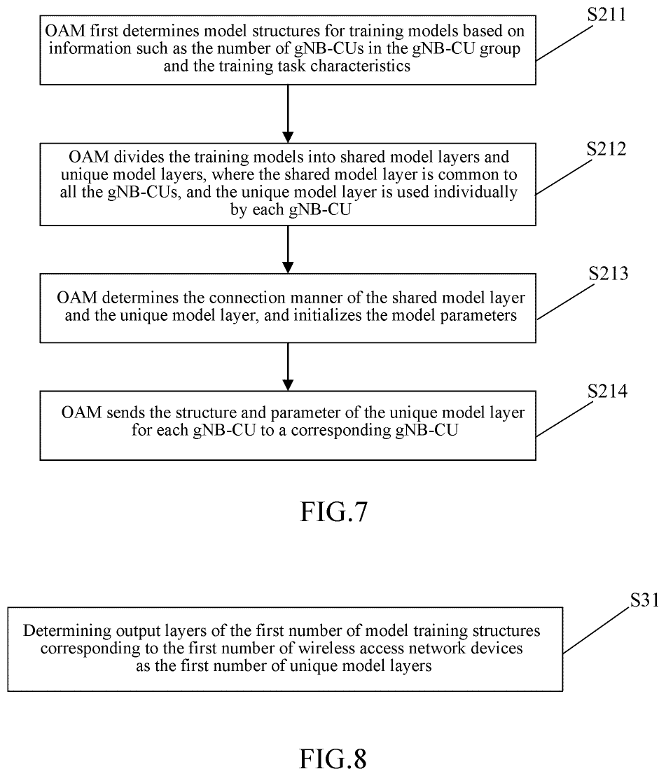

FIG. 7 is a flow diagram of training a model structure of a model training method according to an embodiment. As shown in FIG. 7, it includes the following steps.

In step S211, the OAM first determines model structures for training models based on information such as the number of gNB-CUs in the gNB-CU group and the training task characteristics.

In step S212, the OAM divides the training models into shared model layers and unique model layers, where the shared model layer is common to all the gNB-CUs, and the unique model layer is used individually by each gNB-CU.

In step S213, the OAM determines the connection manner of the shared model layer and the unique model layer, and initializes the model parameters.

In step S214, the OAM sends the structure and parameter of the unique model layer for each gNB-CU to a corresponding gNB-CU.

FIG. 8 is a flowchart of a model training method according to an embodiment. As shown in FIG. 8, the model training method is used in OAM and includes the following steps.

In step S31, output layers of the first number of model training structures corresponding to the first number of wireless access network devices are determined as the first number of unique model layers.

In an embodiment of the present disclosure, the output layer of the model training structure corresponding to each radio access network device in the first number of radio access network devices is determined, and the output layer is determined as the unique model layer to obtain the first number of unique model layers. Each of the unique model layers is used individually for the corresponding wireless access network device for outputting the result of the final classification or regression.

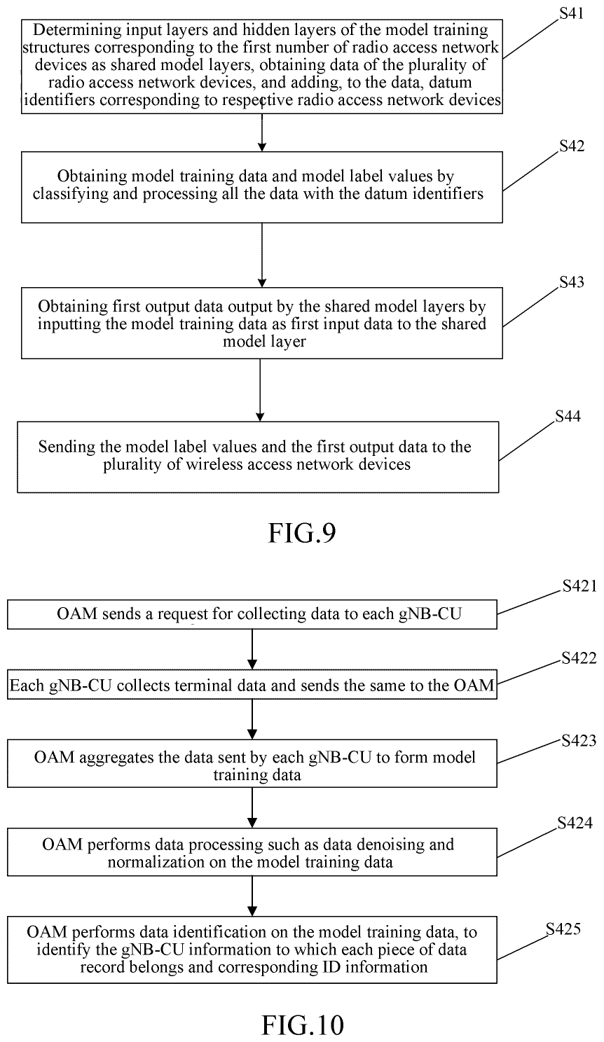

FIG. 9 is a flowchart of a model training method according to an embodiment. As shown in FIG. 9, the model training method is used in OAM and includes the following steps.

In step S41, input layers and hidden layers of the model training structures corresponding to the first number of radio access network devices are determined as shared model layers, data of the plurality of radio access network devices are obtained, and datum identifiers corresponding to respective radio access network devices are added to the data.

In an embodiment of the present disclosure, the input layer and the hidden layer of the model training structure corresponding to each radio access network device in the first data radio access network device are determined, and the input layer and the hidden layer are determined as the shared model layer. The shared model layer is common to all gNB-CUs for extracting feature information of the input data.

In an embodiment of the present disclosure, the OAM may also request model training data from the radio access network device, perform data processing, and identify each piece of training data to identify the radio access network device to which the data belongs and data ID information. Further, the OAM sends the model training data request to each of the managed wireless access network devices. After receiving the model training data request, the wireless access network device sends the model training data request to each of the connected wireless access network devices. Each wireless access network device sends the model training data request to the terminal accessing the wireless access network device, and the terminal, after receiving the model training data request, collects the terminal data and sends the same to the wireless access network device. The wireless access network device aggregates the terminal training data and collects the data of the wireless access network device itself, and sends these data to the wireless access network device connected thereto. The wireless access network device aggregates the wireless access network device data and collects the data of the wireless access network device itself, and sends these data to the OAM.

The wireless access network device information may be identified by 0-1 encoding. Assuming that the number of wireless access network devices is N, N bits are used to record the wireless access network device information. If the bit is 0, it represents that the data does not belong to the corresponding gNB-CU, and if the bit is 1, it represents that the data belongs to the corresponding wireless access network device. The data ID information needs to be consistent with the data ID information at the wireless access network device.

In step S42, model training data and model label values are obtained by classifying and processing all the data with the datum identifiers.

In an embodiment of the present disclosure, the OAM performs data processing such as data denoising, normalization on the model training data to obtain data for model training, including the model training data of the shared model layer and the model label values of the unique model layers.

The model training method according to the embodiments of the present disclosure may expand the amount of data corresponding to the training task to achieve partial data sharing. Moreover, the shared data weakens the network capability to a certain extent and reduces the risk of overfitting.

FIG. 10 is a schematic diagram of a process for collecting and identifying model training data for a training model structure according to an embodiment. As shown in FIG. 10, by taking the wireless access network device is a gNB-CU as an example, it includes:
step S421, the OAM sending a request for collecting data to each gNB-CU;
step S422, each gNB-CU collecting terminal data and sending the same to the OAM;
step S423, the OAM aggregating the data sent by each gNB-CU to form model training data;
step S424, the OAM performing data processing such as data denoising and normalization on the model training data; and
step S425, the OAM performing data identification on the model training data, to identify the gNB-CU information to which each piece of data record belongs and corresponding ID information.

In step S43, first output data output by the shared model layers are obtained by inputting the model training data as first input data to the shared model layers.

In an embodiment of the present disclosure, the OAM takes the model training data as an input to the shared model layers, and the OAM inputs the model training data to the shared model layers in a serial manner. The last layer of the shared model layers has L nodes, and thus each piece of model training data i corresponds to a set of output results zᵢ^{l}, l∈[1,L]. All output results of the shared model layers, i.e., the first output data output from the shared model layers, are obtained. In the present disclosure, the output results of the shared model layers are referred to as the first output data for ease of description.

In step S44, the model label values and the first output data are sent to the plurality of wireless access network devices.

In an embodiment of the present disclosure, after obtaining all the output results (i.e., the first output data) of the model training data, the OAM sends the first output data and the model label values which are the identification information of the model training data to the respective wireless access network devices.

The model training data provided by the present disclosure can enable a plurality of model training tasks to be performed synergistically, which will increase noise with each other, thereby improving the generalization of the model.

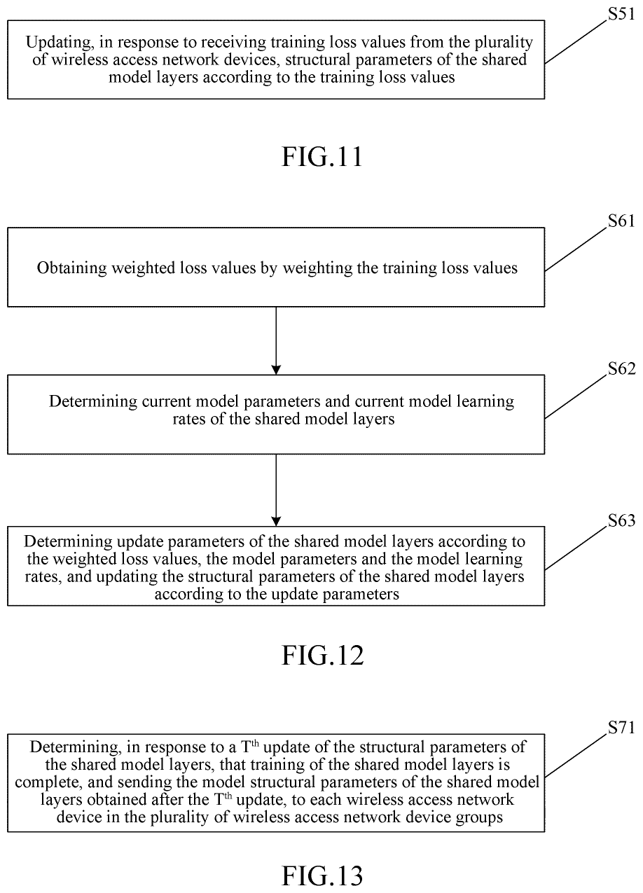

FIG. 11 is a flowchart of a model training method according to an embodiment. As shown in FIG. 11, the model training method is used in OAM and includes the following steps.

In step S51, in response to receiving training loss values from the plurality of wireless access network devices, structural parameters of the shared model layers are updated according to the training loss values.

In an embodiment of the present disclosure, the OAM receives the training loss values sent by the plurality of wireless access network devices and updates structural parameters of the shared model layers based on the respective loss values.

FIG. 12 is a flowchart of a model training method according to an embodiment. As shown in FIG. 12, the model training method is used in OAM and includes the following steps.

In step S61, weighted loss values are obtained by weighting the training loss values.

In an embodiment of the present disclosure, if the current training loss values are training loss values sent by a plurality of radio access network devices for the t^{th} time, the OAM weights the training loss values based on the amount of data, the learning effect and other factors of each gNB-CU. The training loss value may be weighted by referring to the following formula:

$${loss}_{t} = {\sum }_{k = 1}^{K} {w}_{k} {loss}_{t}^{k}$$

where lossₜ^{k} is the training loss value, K is the number of gNB-CUs, and Wₖ is the weight of the training loss value of the k^{th} gNB-CU.

The calculation of Wₖ includes two aspects, one is the proportion of the amount of training data of each gNB-CU to the total amount of data, and the other one is the influence of the learning effect, such as the accuracy of the training model and the difficulty of the learning task.

In step S62, current model parameters and model learning rates of the shared model layers are determined.

In step S63, update parameters of the shared model layers are determined according to the weighted loss values, the model parameters and the model learning rates, and the structural parameters of the shared model layers are updated according to the update parameters.

In an embodiment of the present disclosure, the OAM determines to update the structural parameters of the shared model layers by using the weighted training loss values, the model update method, and the selected structural parameters. For example, the parameters of the shared model layers are updated using the SGD algorithm, which may refer to the following formula:

$${b}_{t + 1} = {b}_{t} - {β}_{t} * ∇ {loss}_{t}$$

where bₜ denotes the structural parameters of the shared model layers to be updated in the t^{th} round, lossₜ denotes the weighted training loss value calculated in the t^{th} round, and βₜ denotes the learning rate in the t^{th} round.

FIG. 13 is a flowchart of a model training method according to an embodiment. As shown in FIG. 13, the model training method is used in OAM and includes the following steps.

In step S71, in response to a T^{th} update of the structural parameters of the shared model layers, it determines that training of the shared model layers is complete, and the model structural parameters of the shared model layers obtained after the T^{th} update are sent to each wireless access network device in the plurality of wireless access network device groups.

T is a predetermined number of times to update the shared model layers and the unique model layers, and the structural parameters of the shared model layers are configured for the wireless access network devices to synthesize a model to which the wireless access network device subscribes.

In an embodiment of the present disclosure, the OAM, after completing the updating of the structural parameters of the shared model layers for the T^{th} time, sends the structural parameters for updating the shared model layers for the T^{th} time, to each wireless access network device. After the wireless access network device receives the model information, as the wireless access network device stores the connection manner between the shared model layer and the unique model layer, the wireless access network device may stitch the two models together according to a specific connection and integrate them into a complete model for model inference.

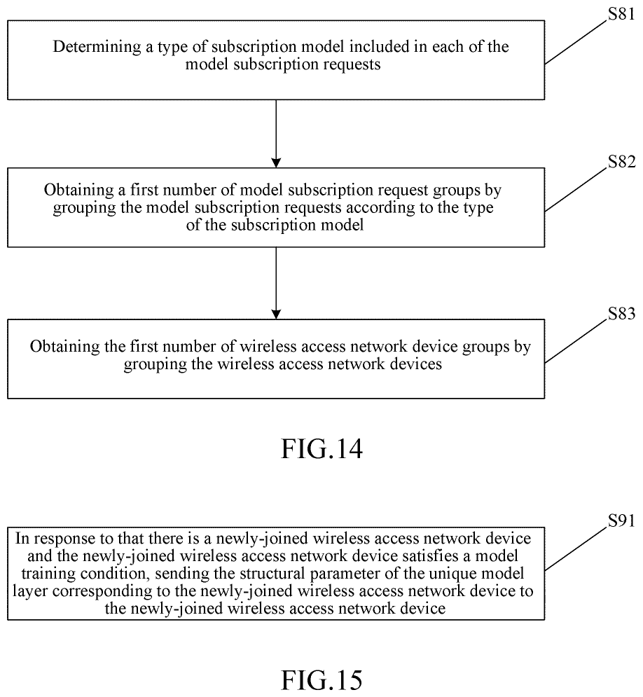

FIG. 14 is a flowchart of a model training method according to an embodiment. As shown in FIG. 14, the model training method is used in OAM and includes the following steps.

In step S81, a type of subscription model included in each of the model subscription requests is determined.

In an embodiment of the present disclosure, the OAM determines the type of the requested model training task included in the model subscription request sent by each wireless access network device, for example, the type may be a load prediction model training task, a network decision training task or the like.

In step S82, a first number of model subscription request groups are obtained by grouping the model subscription requests according to the type of the subscription model.

In an embodiment of the present disclosure, the OAM groups the received model subscription requests according to the type of the model training task or according to the similarity between the types of the model training tasks, determines a plurality of different groups of model subscription requests, and further obtains a first of numbers of model subscription request groups.

In step S83, the first number of wireless access network device groups are obtained by grouping the wireless access network devices.

In an embodiment of the present disclosure, the OAM groups the corresponding wireless access network devices based on the first number of model subscription request groups to obtain the first number of wireless access network device groups.

In the present disclosure, by grouping the wireless access network devices, the training efficiency may be improved. Moreover, the OAM adopts a collaborative training method, in which the more similar the training tasks of respective wireless access network devices involved in training are, the better the training effect is, so the wireless access network devices are grouped for training.

FIG. 15 is a flowchart of a model training method according to an embodiment. As shown in FIG. 15, the model training method is used in OAM and includes the following steps.

In step S91, in response to that there is a newly-joined wireless access network device and the newly-joined wireless access network device satisfies a model training condition, the structural parameter of the unique model layer corresponding to the newly-joined wireless access network device is sent to the newly-joined wireless access network device.

In an embodiment of the present disclosure, when a new wireless access network device requests to join the wireless access network device group, the new wireless access network device first sends a request to join the current gNB-CU group to the OAM. after receiving the request, the OAM determines whether the new wireless access network device satisfies the condition for joining the current wireless access network device group. If the new wireless access network device satisfies the condition, it may join the current wireless access network device group for model training, and if the new wireless access network device does not satisfy the condition, it cannot join the current wireless access network device group. If the new wireless access network device satisfies the condition, the OAM updates the information of the radio access network device group and adds the new radio access network device to the list of radio access network devices participating in the model training. The OAM updates the training model structures based on the information such as the training task characteristic of the new radio access network device and sends the unique model layer structures and parameters of the new radio access network device to the new radio access network device. The OAM sends the output results of the shared model layers to the new radio access network device, and the new wireless access network device updates the structural parameters of the unique model layer for model training.

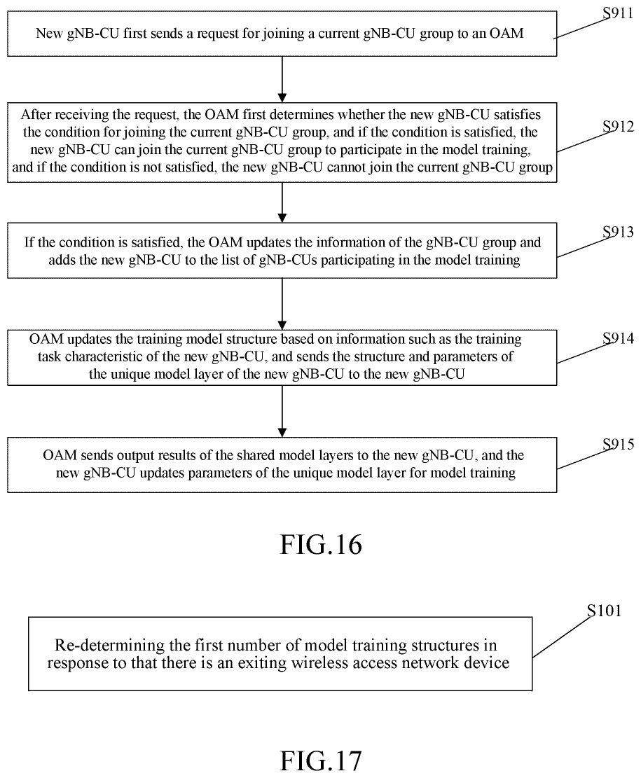

In an embodiment, it is illustrated by taking that the wireless access network device is a gNB-CU as an example. FIG. 16 is a flowchart of newly adding a wireless access network device in a model training method according to an embodiment. As shown in FIG. 16, it includes the following steps.

In step S911, a new gNB-CU first sends a request for joining a current gNB-CU group to an OAM.

In step S912, after receiving the request, the OAM first determines whether the new gNB-CU satisfies the condition for joining the current gNB-CU group, and if the condition is satisfied, the new gNB-CU can join the current gNB-CU group to participate in the model training, and if the condition is not satisfied, the new gNB-CU cannot join the current gNB-CU group.

In step S913, if the condition is satisfied, the OAM updates the information of the gNB-CU group and adds the new gNB-CU to the list of gNB-CUs participating in the model training.

In step S914, the OAM updates the training model structure based on information such as the training task characteristic of the new gNB-CU, and sends the structure and parameters of the unique model layer of the new gNB-CU to the new gNB-CU.

In step S915, the OAM sends output results of the shared model layers to the new gNB-CU, and the new gNB-CU updates parameters of the unique model layer for model training.

In some embodiments of the present disclosure, in the training process of the current gNB-CU group, there exists a new terminal that sends an analysis subscription request to the gNB-CU, and in turn, there exists a new gNB-CU that sends a model subscription request to the OAM. The OAM, after receiving the request sent by the new gNB-CU, first determines whether the gNB-CU satisfies the condition to join the current gNB-CU group. In an embodiment, the method of determining whether the new gNB-CU satisfies the condition for joining the current gNB-CU group is to compare the similarity between the analysis request type in the terminal model subscription request information of the new gNB-CU and the analysis request type in the terminal model subscription request information of the current gNB-CU group, and if the similarity is high, the new gNB-CU satisfies the condition and can join the current gNB-CU group to participate in model training, and if the similarity is low, the new gNB-CU does not satisfy the condition and cannot join the current gNB-CU group to participate in model training. For example, if the new gNB-CU requests the training model to perform the prediction task and the training model of the current gNB-CU group is used for the decision task, the similarity therebetween is low, and the gNB-CU is not allowed to join the current gNB-CU group. If the new gNB-CU satisfies the condition, the OAM adds it to the list participating in model training, updates the information of the gNB-CU group, and starts to send data information to the new gNB-CU. On the basis of the existing training model and without changing the shared model layer, the OAM modifies the structure of the unique model layer, including adding branches, increasing the number of nodes of the output layer, changing the connection manner with the shared model layer or the like, updates the structure of the training model, and sends the structure and parameters of the newly added unique model layer to the new gNB-CU as the unique model layer of the new gNB-CU.

FIG. 17 is a flowchart of a model training method according to an embodiment. As shown in FIG. 17, the model training method is used in OAM and includes the following steps.

In step S101, the first number of model training structures is re-determined in response to that there is an exiting wireless access network device.

In an embodiment of the present disclosure, when a wireless access network device requests to exit the wireless access network device group, the wireless access network device first sends a request for exiting the current wireless access network device group to the OAM. When receiving the request, the OAM deletes relevant information about the wireless access network device in the list of wireless access network devices participating in the model training, and no longer sends data to the wireless access network device. The OAM deletes the unique model layer of the wireless access network device and updates the training model structure. The wireless access network device no longer participates in the model training process of the wireless access network device group. If the wireless access network device has not completed the model training in the current round, the wireless access network device continues to complete the current round of model training but no longer performs parameter uploads.

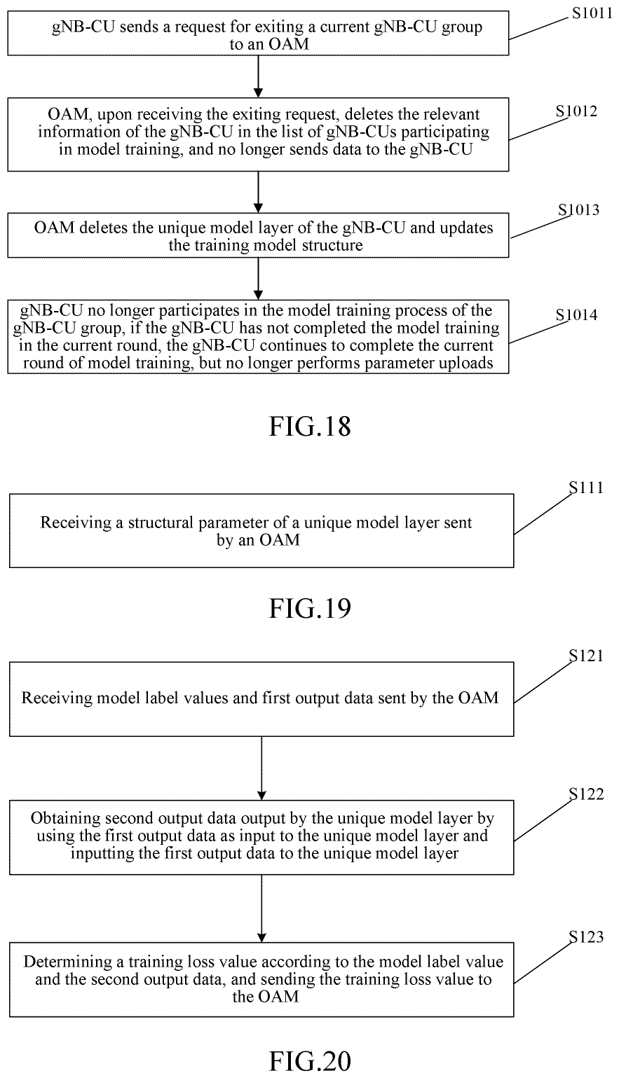

In an embodiment, it is illustrated by taking that the wireless access network device is a gNB-CU as an example. FIG. 18 is a flowchart of a wireless access network device exiting in a model training method according to an embodiment. As shown in FIG. 18, it includes the following steps.

In step S1011, a gNB-CU sends a request for exiting a current gNB-CU group to an OAM.

In step S1012, the OAM, upon receiving the exiting request, deletes the relevant information of the gNB-CU in the list of gNB-CUs participating in model training, and no longer sends data to the gNB-CU.

In step S1013, the OAM deletes the unique model layer of the gNB-CU and updates the training model structure.

In step S1014, the gNB-CU no longer participates in the model training process of the gNB-CU group.

In some embodiments of the present disclosure, during the training process of the current gNB-CU group, there exists a terminal that cancel an analysis subscription request to a gNB-CU, and in turn, there is a gNB-CU that sends a request for cancelling a model subscription to the OAM to request exiting from the current gNB-CU group. When receiving the request, the OAM deletes the gNB-CU from a list participating in the model training, and updates the information of the gNB-CU group and no longer sends data information to the gNB-CU. On the basis of the existing training model and without changing the shared model layer, the OAM modifies the structure of the unique model layer, including deleting branches, reducing the number of nodes of the output layer, changing the connection manner with the shared model layer or the like, updates the structure of the training model, and deletes the structure of the unique model layer of the gNB-CU. The gNB-CU no longer participates in the model training process of the gNB-CU group. If the gNB-CU has not completed the model training in the current round, the gNB-CU continues to complete the current round of model training, but no longer performs parameter uploads.

Based on the same concept, an embodiment of the present disclosure also provides a model training method.

FIG. 19 is a flowchart of a model training method according to an embodiment. As shown in FIG. 19, the model training method is used in a wireless access network device and includes:

step S111, receiving a structural parameter of a unique model layer sent by an OAM.

In an embodiment of the present disclosure, the wireless access network device receives the unique model layer sent by the OAM. The unique model layer is determined by the OAM dividing a first number of model training structures, and the first number of model training structures are determined by the OAM according to model subscription requests of a first number of wireless access network devices included in a wireless access network device group.

By taking the wireless access device is gNB-CU as an example, the OAM sends the structural parameter information of the unique model layers to each gNB-CU in accordance with a mapping table from each gNB-CU to each connection manner, and each gNB-CU receives the model information and uses the unique model layer as a local model for model training and updating.

The model training method provided by the embodiments of the present disclosure may transfer a portion of the model training work to the wireless access network device, which may reduce the amount of uploaded data, be conducive to the balanced allocation of resources, and reduce data security risk.

FIG. 20 is a flowchart of a model training method according to an embodiment. As shown in FIG. 20, the model training method is used in a wireless access network device and includes the following steps.

In step S121, model label values and first output data sent by the OAM are received.

In an embodiment of the present disclosure, the wireless access network device receives the first output data and the model label values sent by the OAM, and each wireless access network device determines the model label value belonging to the wireless access network device itself based on wireless access network device identification information of the model label values, and screens the first output data output from the shared model layers of these model label values.

In step S122, second output data output by the unique model layer are obtained by using the first output data as input to the unique model layer and inputting the first output data to the unique model layer.

In an embodiment of the present disclosure, the wireless access network device screens the first output data corresponding to the device itself output from the shared model layers, and inputs the same into the unique model layer received by the wireless access network device to obtain the second output data of the unique model layer.

Each wireless access network device stores structure and parameter information of the unique model layer sent by the OAM, which includes a connection manner between the unique model layer and the shared model layer, and each wireless access network device may input the output results of the shared model layer into the unique model layer according to the connection manner between the unique model layer and the shared model layer.

In an embodiment, the wireless access network device determines the output results of the shared output layer belong to the device itself, serially inputs the same into the unique model layer, and obtains output results of the unique model layer, therefore each piece of model training data i corresponds to a set of output results when the number of nodes in the output layer is N.

In step S123, a training loss value is determined according to the model label value and the second output data, and the training loss value is sent to the OAM.

In an embodiment of the present disclosure, the wireless access network device determines the model label value corresponding to the device itself, and based on the model label value and the second output data, determines the training loss value. The training loss value may be determined with reference to the following formula:

$$loss = \frac{1}{I} {\sum }_{i = 1}^{I} {( {y}_{i} - {\overline{y}}_{i} )}^{2}$$

where loss is the training loss value, I is the amount of model training data belonging to the current gNB-CU, yᵢ is the output result of the data i passing through the unique model layer, and y̅ᵢ is the label value of the data i.

In some embodiments of the present disclosure, appropriate loss functions may also be selected for different tasks.

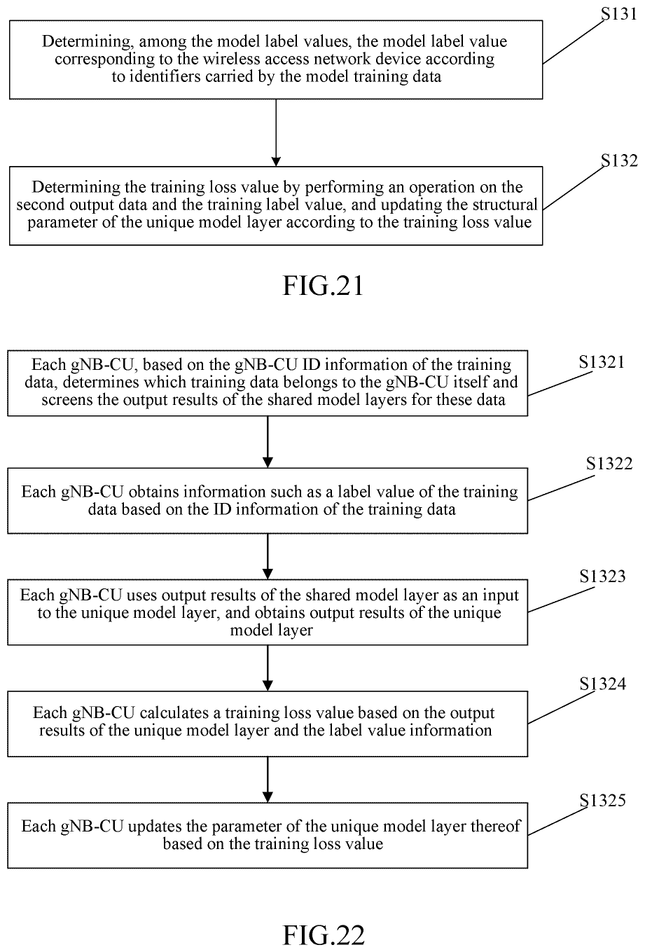

FIG. 21 is a flowchart of a model training method according to an embodiment. As shown in FIG. 21, the model training method is used in a wireless access network device, an includes the following steps.

In step S131, the model label value corresponding to the wireless access network device is determined among the model label values according to identifiers carried by the model training data.

In an embodiment of the present disclosure, each wireless access network device obtains the information such as the label value of each piece of model training data by searching in database of the wireless access network according to the ID information of the model training data that has been determined to belong to the device itself.

After receiving the ID information of the model training data, the wireless access network device determines whether the training data belongs to the wireless access network device itself by parsing the N-bit wireless access network device information carried by the wireless access network device, and then determines all the training data that belong to the wireless access network device itself, and obtains the data ID information and the output results of the shared model layer thereof.

In step S132, the training loss value is determined by performing an operation on the second output data and the training label value, and the structural parameter of the unique model layer is updated according to the training loss value.

In an embodiment of the present disclosure, each gNB-CUk updates the parameter of the unique model layer by using the training loss value obtained by itself, the model updating method, and the selected structural parameters, such as the stochastic gradient descent (SGD) algorithm and the optimization algorithm Adam, for example, the parameter of the unique model layer is updated by using the SGD algorithm, which may refer to the following formula:

$${x}_{t + 1}^{k} = {x}_{t}^{k} - {α}_{t}^{k} * ∇ {loss}_{t}^{k}$$

where xₜ^{k} denotes the parameter of the unique model layer to be updated in the t^{th} round, xₜ₊₁^{k} denotes the parameter of the unique model layer after being updated in the t^{th} round, ∇lossₜ^{k} denotes the gradient of the training loss value calculated in the t^{th} round, and αₜ^{k} denotes the learning rate in the t^{th} round.

In an embodiment, it is illustrated by taking that the wireless access network device is a gNB-CU as an example. FIG. 22 is a flowchart of updating a parameter of a unique model layer in a model training method according to an embodiment. As shown in FIG. 22, it includes the following steps.
In step S1321, each gNB-CU, based on the gNB-CU ID information of the training data, determines which training data belongs to the gNB-CU itself and screens the output results of the shared model layers for these data.
In step S1322, each gNB-CU obtains information such as a label value of the training data based on the ID information of the training data.
In step S1323, each gNB-CU uses output results of the shared model layer as an input to the unique model layer, and obtains output results of the unique model layer.
In step S1324, each gNB-CU calculates a training loss value based on the output results of the unique model layer and the label value information.
In step S1325, each gNB-CU updates the parameter of the unique model layer thereof based on the training loss value.

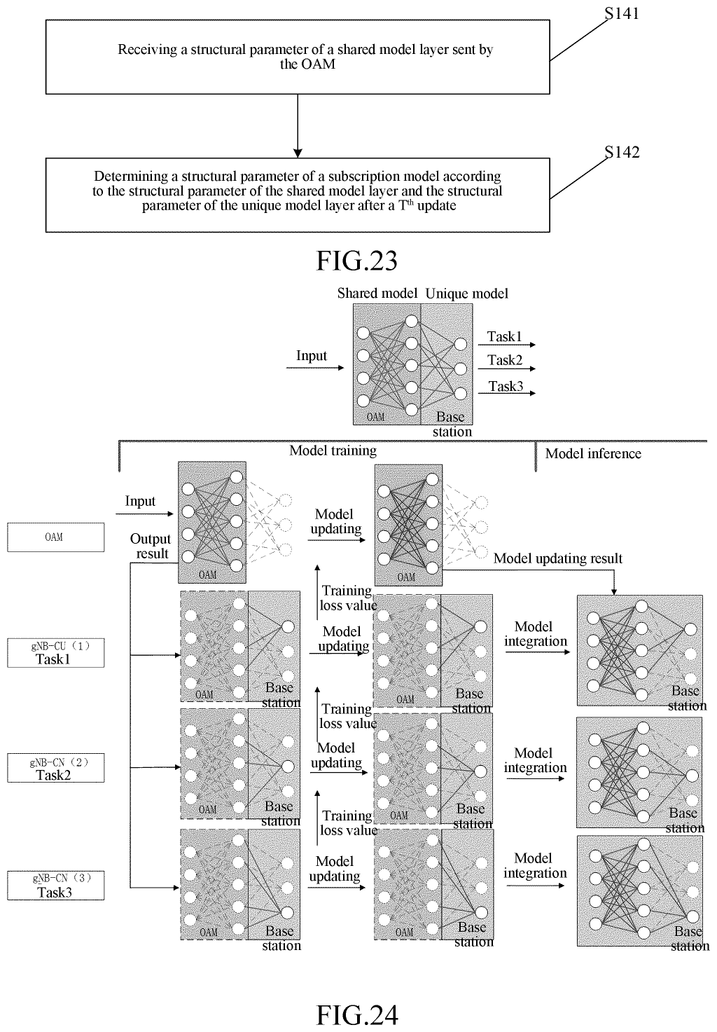

FIG. 23 is a flowchart of a model training method according to an embodiment. As shown in FIG. 23, the model training method is used in a wireless access network device and includes:
step S141, receiving a structural parameter of a shared model layer sent by the OAM; and
step S142, determining a structural parameter of a subscription model according to the structural parameter of the shared model layer and the structural parameter of the unique model layer after a T^{th} update.

T is a predetermined number of times to update the shared model layer and the unique model layer.

In an embodiment of the present disclosure, the OAM sends the model parameters of the shared model layers to each wireless access network device in the wireless access network device group. After the wireless access network device receives the structural parameters of the shared model layers, based on the connection manner between the shared model layer and the unique model layer stored thereon, the wireless access network device may stitch the structural parameters of the two models together according to a specific connection to integrate them into a complete model and thus obtain the structural parameters of the model, which may be used for model inference.

In some embodiments of the present disclosure, after the wireless access network device determines a complete model, the complete model can be used for model inference, and a model inference process includes the following.

(1) The wireless access network device collects model inference data, performs model inference based on the inference model, sends an inference result to the terminal, and at the same time feeds the model inference result back to the OAM.

Further, the wireless access network device sends a request for model training data to each of the wireless access network devices connected thereto. Each wireless access network device sends the request for model training data to all terminals accessing the wireless access network device. After receiving the request for model training data, the terminal collects terminal data and sends the same to the wireless access network device. The wireless access network device aggregates the terminal data and collects the data of the wireless access network device itself, and sends the same to the wireless access network device connected thereto. The wireless access network device aggregates the wireless access network device data and collects the data of the wireless access network device itself to form the model inference data.

(2) After collecting the model inference data, the wireless access network device performs model inference based on the integrated inference model to obtain an inference result and send the inference result to the terminal.

Further, the wireless access network device sends the inference result to the wireless access network device accessed by the terminal. The wireless access network device sends the inference result to the terminal. After completing the model inference, the wireless access network device feeds the inference result back to the OAM. The inference result that needs to be fed back by the wireless access network device is information such as model inference accuracy.

(3) The terminal executes the network optimization policy based on the model inference result, collects network performance data and feeds the same back to the OAM for model training.

The terminal executes a corresponding network optimization policy (e.g., cell switching, cell activation or the like) according to the model inference result (e.g., prediction result, decision result, or the like). At the same time, the terminal collects network-side performance data (e.g., measurement result, data related to the success or failure of the cell switching, or the like) and feeds them back to the wireless access network device, which then feeds them back to the OAM for model training.

In some embodiments of the present disclosure, the process of collaborating model training and model inference may refer to FIG. 24. FIG. 24 is a schematic diagram of model training and model inference of a model training method according to an embodiment. As shown in FIG. 24, it includes a structure of a shared model layer and a unique model layer, the shared model layer includes an input layer and a hidden layer, the unique model layer includes an output layer, the shared model layer is trained on the OAM, the unique model layer is trained on a radio access network device (e.g., a gNB-CU), and each of the gNB-CUs only retains one branch of the unique model layers.

The OAM obtains the output result of the shared model layer and sends the same to each gNB-CU. Each gNB-CU then obtains the output result of the unique model layer thereof based on the output result of the shared model layer and calculates the training loss value to update the model parameter of the unique model layer. Each gNB-CU sends the training loss value to the OAM, which updates the model parameter of the shared model layer, and continues training. The OAM sends the model information of the trained shared model layer to each gNB-CU. Each gNB-CU integrates the shared model layer with the local unique model layer to form a complete inference model. Each gNB-CU performs model inference using the inference model.

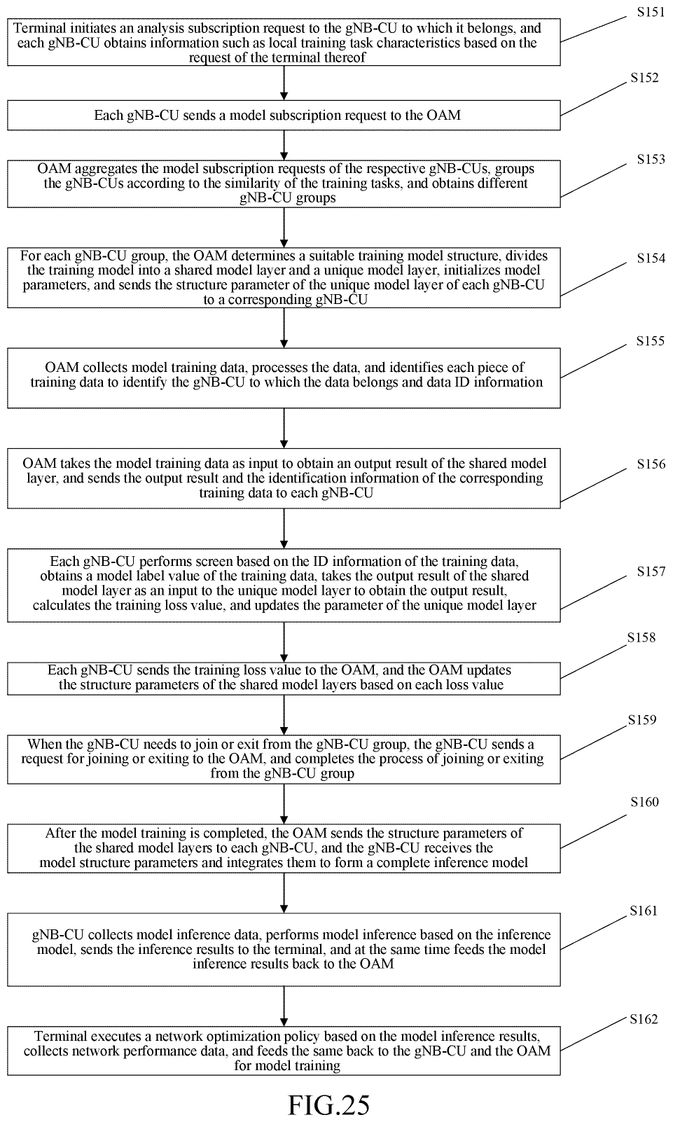

In some embodiments of the present disclosure, the processes of model training and model inference will be illustrated in conjunction with the interaction between the OAM, the radio access network device (e.g., gNB-CU) and the terminal. FIG. 25 is a flowchart of a model training method and a model inference method according to an embodiment. As shown in FIG. 25, it includes the following steps.

In step S151, the terminal initiates an analysis subscription request to the gNB-CU to which it belongs, and each gNB-CU obtains information such as local training task characteristics based on the request of the terminal thereof.

In step S152, each gNB-CU sends a model subscription request to the OAM.

In step S153, the OAM aggregates the model subscription requests of the respective gNB-CUs, groups the gNB-CUs according to the similarity of the training tasks, and obtains different gNB-CU groups.

In step S154, for each gNB-CU group, the OAM determines a suitable training model structure, divides the training model into a shared model layer and a unique model layer, initializes a model parameter, and sends the structure parameter of the unique model layer of each gNB-CU to a corresponding gNB-CU.

In step S155, the OAM collects model training data, processes the data, and identifies each piece of training data to identify the gNB-CU to which the data belongs and data ID information

In step S156, the OAM takes the model training data as input to obtain an output result of the shared model layer, and sends the output result and the identification information (ID) of the corresponding training data to each gNB-CU.

In step S157, each gNB-CU performs screen based on the ID information of the training data, obtains a model label value of the training data, takes the output result of the shared model layer as an input to the unique model layer to obtain the output result, calculates the training loss value, and updates the parameter of the unique model layer.

In step S158, each gNB-CU sends the training loss value to the OAM, and the OAM updates the structure parameters of the shared model layers based on each loss value

In step S159, when the gNB-CU needs to join or exit from the gNB-CU group, the gNB-CU sends a request for joining or exiting to the OAM, and completes the process of joining or exiting from the gNB-CU group.

In step S160, after the model training is completed, the OAM sends the structure parameters of the shared model layers to each gNB-CU, and the gNB-CU receives the model structure parameters and integrates them to form a complete inference model.

In step S161, the gNB-CU collects model inference data, performs model inference based on the inference model, sends the inference results to the terminal, and at the same time feeds the model inference results back to the OAM.

In step S162, the terminal executes a network optimization policy based on the model inference results, collects network performance data, and feeds the same back to the gNB-CU and the OAM for model training.

It should be noted that in an embodiment, the description of the interaction process between the OAM, the wireless access network device (e.g., gNB-CU) and the terminal may refer to the above embodiment, which will not be repeated herein.

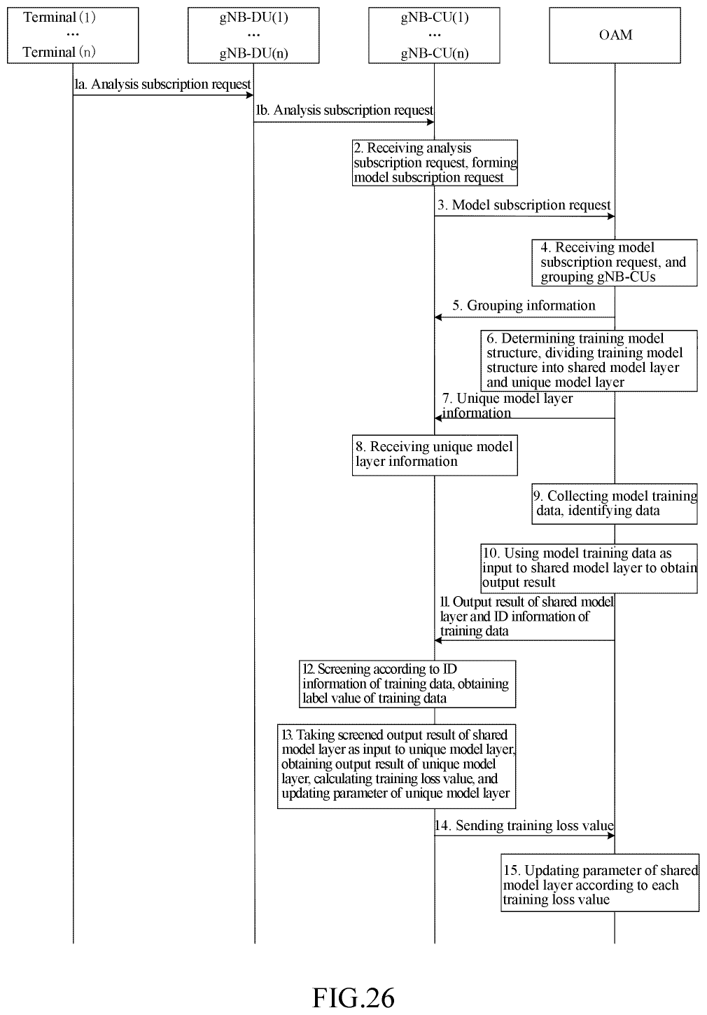

FIG. 26 is a schematic diagram of a protocol and interface for model training of a model training method according to an embodiment. As shown in FIG. 26, it mainly relates to a terminal, a radio access network device (e.g., a gNB-DU) accessed by the terminal, a radio access network device (e.g., a gNB-CU) accessed by the terminal, and an OAM provided by an embodiment of the present disclosure, which is specifically as follows.

1a. the terminal sends analysis subscription request signaling to the gNB-DU; 1b. the gNB-DU receives the analysis subscription request signaling sent by the terminal and sends the analysis subscription request signaling to the gNB-CU; 2. the gNB-CU receives the analysis subscription request signal sent by the gNB-DU and forms model subscription request signaling; 3. the gNB-CU sends the model subscription request signaling to the OAM; 4. the OAM receives the model subscription request signaling, obtains information contained in the signaling, and groups the gNB-CUs; 5. the OAM sends the grouping information to each gNB-CU in the gNB-CU group; 6. the OAM determines a training model structure and divides the model into a shared model layer and a unique model layer; 7. the OAM sends the model information in the unique model layer to each gNB-CU in the current gNB-CU group; 8. each gNB-CU receives the model information of the unique model layer for model training; 9. the OAM collects model training data, and processes and identifies the data after completing the data collection; 10. the OAM uses the model training data as the input of the shared model layer to obtain an output result; 11. the OAM sends the output result of the shared model layer and the identification (ID) information of the training data to each gNB-CU; 12. each gNB-CU screens the output result corresponding to the training data belonging to the current gNB-CU according to the ID information of the training data and obtains label values of these training data; 13. each gNB-CU takes the screened output result of the shared model layer as input to the unique model layer, obtains the output result of the unique model layer, calculates the training loss value, and updates the parameter of the unique model layer; 14. each gNB-CU sends the calculated training loss value to the OAM; and 15. the OAM receives the aggregated respective training loss values and updates the parameter of the shared model layer.

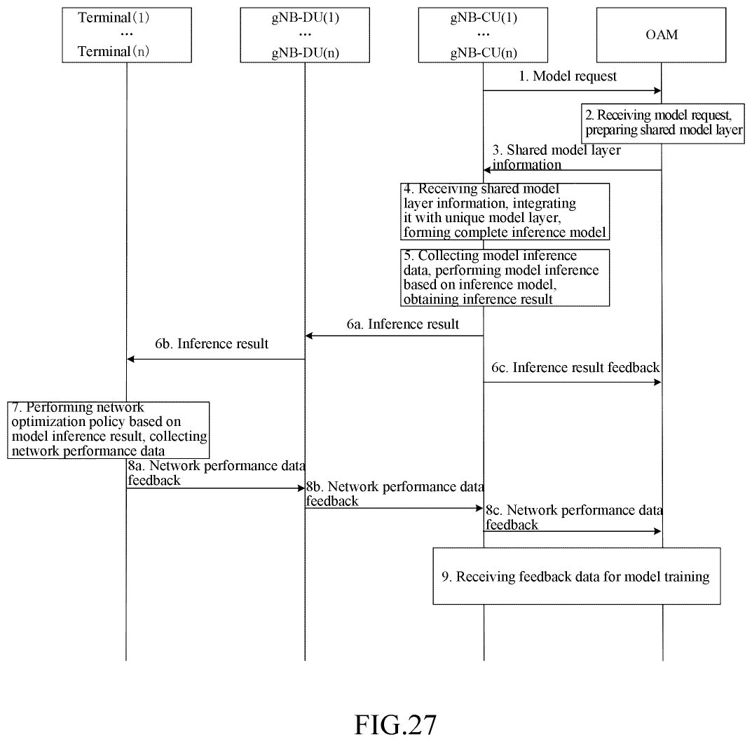

FIG. 27 is a schematic diagram of a protocol and interface for model inference of a model training method according to an embodiment. As shown in FIG. 27, it mainly relates to a terminal, a radio access network device (e.g., a gNB-DU) accessed by the terminal, a radio access network device (e.g., a gNB-CU) accessed by the terminal, and an OAM provided by an embodiment of the present disclosure, which is specifically as follows.

1. each gNB-CU sends model request signaling to the OAM; 2. the OAM receives the model request signaling and prepares model information of a shared model layer; 3. the OAM sends the model information of the shared model layer to each gNB-CU; 4. each gNB-CU receives the information of the shared model layer, integrates it with a local unique model layer of the gNB-CU, and forms a complete inference model; 5. each gNB-CU collects model inference data, performs model inference based on the inference model, and obtains the inference result; 6a. each gNB-CU sends the model inference result to the gNB-DU connected thereto; 6b. each gNB-DU sends the model inference result to the terminal connected thereto; 6c. each gNB-CU sends model inference feedback result to the OAM; 7. the terminal performs network optimization policy based on the model inference result, and collects the network performance data; 8a. the terminal feeds the network performance data to the gNB-DU connected thereto; 8b. the gNB-DU feeds the network performance data to the gNB-CU connected thereto; 8c. the gNB-CU feeds the network performance data back to the OAM; and 9. the gNB-CU and the OAM receive the network performance feedback data for model training.

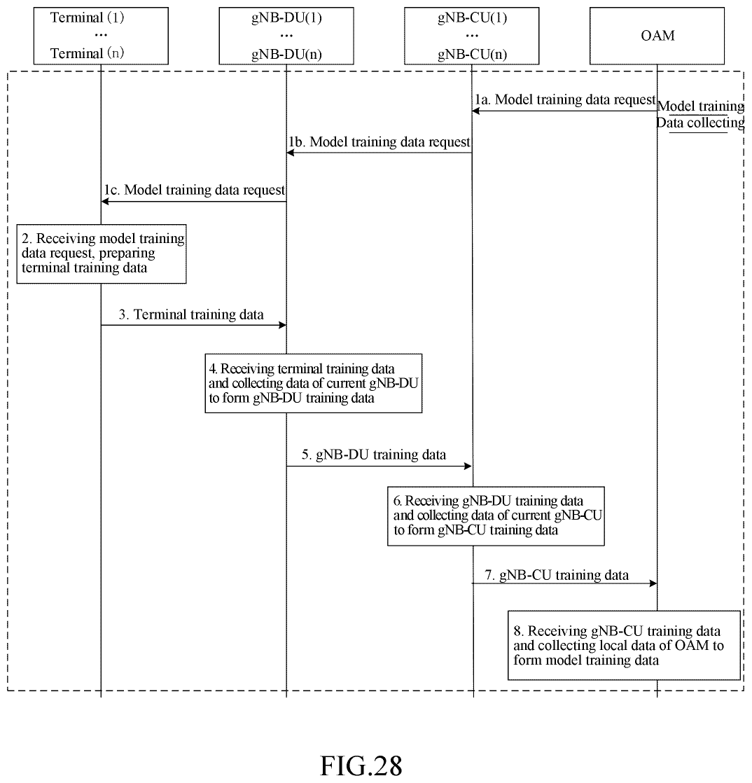

FIG. 28 is a schematic diagram of a protocol and interface for model training data collection of a model training method according to an embodiment. As shown in FIG. 28, it mainly relates to a terminal, a radio access network device (e.g., a gNB-DU) accessed by the terminal, a radio access network device (e.g., a gNB-CU) accessed by the terminal, and an OAM provided by an embodiment of the present disclosure.

1a. the OAM sends model training data request signaling to each gNB-CU; 1b. each gNB-CU sends the model training data request signaling to the gNB-DU connected thereto; 1c. each gNB-DU sends the model training data request signaling to the terminal connected thereto; 2. the terminal receives the model training data request and prepares terminal training data; 3. the terminal sends the training data to the gNB-DU connected thereto; 4. each gNB-DU receives the terminal training data and collects the data of the current gNB-DU to form gNB-DU training data; 5. each gNB-DU sends the training data to the gNB-CU connected thereto; 6. each gNB-CU receives the gNB-DU training data and collects the data of the current gNB-CU to form the gNB-CU training data; 7. each gNB-CU sends the training data to the OAM; and 8. the OAM receives the gNB-CU training data and collects local data of the OAM to form the model training data.

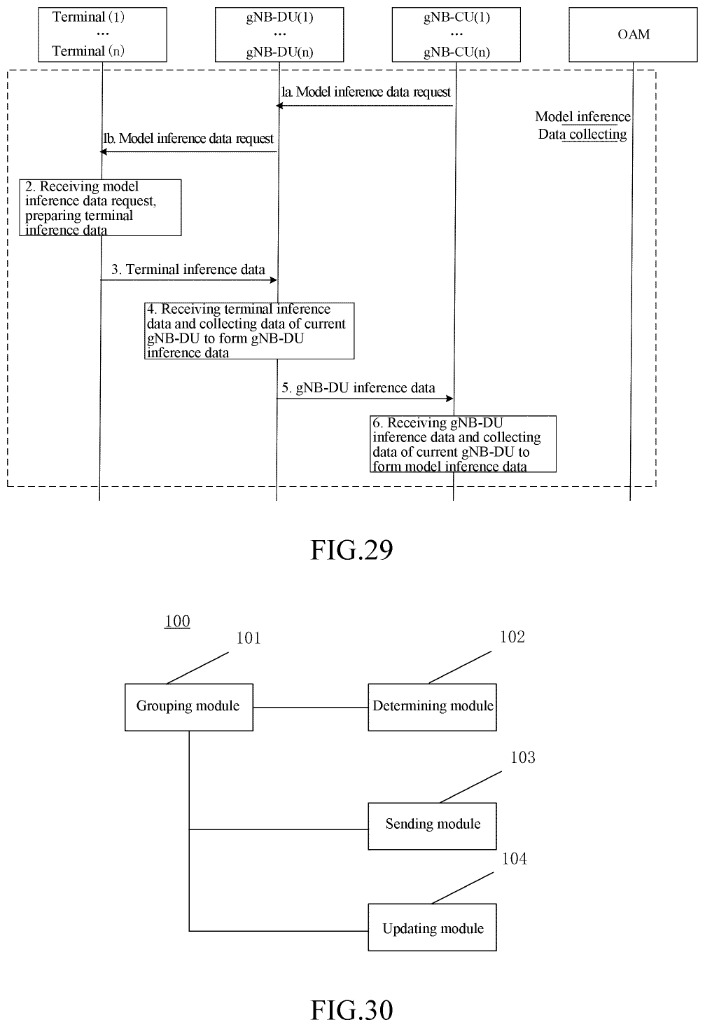

FIG. 29 is a schematic diagram of a protocol and interface for model inference data collection of a model training method according to an embodiment. As shown in FIG. 29, it mainly relates to a terminal, a radio access network device (e.g., a gNB-DU) accessed by the terminal, a radio access network device (e.g., a gNB-CU) accessed by the terminal, and an OAM provided by an embodiment of the present disclosure.
1a. the current gNB-CU sends model inference data request signaling to the gNB-DU connected thereto; 1b. each gNB-DU sends the model inference data request signaling to the terminal connected thereto; 2. the terminal receives the model inference data request and prepares terminal inference data; 3. the terminal sends the inference data to the gNB-DU connected thereto; 4. each gNB-DU receives the terminal inference data and collects data of the current gNB-DU to form the gNB-DU inference data; 5. each gNB-DU sends the inference data to the gNB-CU connected thereto; 6. the current gNB-CU receives the gNB-DU inference data and collects data of the current gNB-CU to form the model inference data.

The technical solution of embodiments of the present disclosure may have the following beneficial effects.
1: A plurality of gNB-CUs perform training collaboratively. The OAM maintains the shared model layer, the gNB-CU maintains the unique model layer, and the OAM must inform each gNB-CU in advance of the connection manner between the unique model layer and the shared model layer, so that the gNB-CU, after receiving an output result from the shared model layer, can quickly input the output result into the unique model layer to update the model parameter.
2: The OAM collects model training data. The OAM first sends a model training data request to each gNB-CU in the gNB-CU group, then the gNB-CU will send the model training data request to the gNB-DU connected thereto, then the gNB-DU will send the model training data request to the terminal, and after the terminal sends the data to the gNB-DU, the gNB-DU will send the data from the terminal and local data collected by the gNB-DU together to the gNB-CU, and similarly, the gNB-CU will send the data from the gNB-DU and local data collected by the gNB-CU together to the OAM.
3: The OAM needs to perform data identification on the model training data. The identification information includes the gNB-CU to which the training data belongs and the data ID, and the like. The gNB-CU information is identified so that each gNB-CU can filter the training data belonging to the gNB-CU itself accordingly, and thus use this portion of the data for updating the unique model layer thereof. The data ID information is identified so that each gNB-CU can retrieve information such as the label value of the data based on the ID information, which is used to calculate the training loss value.
4: In the scenario where a gNB-CU requests to join in or exit from the gNB-CU group, after the gNB-CU sends the request, the OAM needs to update the training model structure and at the same time update the list of the gNB-CUs to start transmitting the data information or to stop transmitting the data information.

Based on the same concept, an embodiment of the present disclosure also provides a model training device.

It is to be understood that the model training device provided in an embodiment of the present disclosure includes a corresponding hardware structure and/or software module for performing respective functions, in order to achieve the above-described functions. In combination with the units and algorithmic steps of the various examples disclosed in the embodiments of the present disclosure, the embodiment of the present disclosure can be implemented in the form of hardware or a combination of hardware and computer software. Whether a particular function is performed as hardware or computer software driving hardware depends on the particular application and design constraints of the technical solution. A person skilled in the art may use a different manner for each particular application to implement the described functionality, but such implementation should not be considered as going beyond the scope of the technical solution of the embodiment of the present disclosure.

FIG. 30 is a block diagram of a model training device according to an embodiment. Referring to FIG. 30, the device 100 is applied to an operation administration and maintenance (OAM) entity and includes a grouping module 101, a determining module 102, and a sending module 103.

The grouping module 101 is configured to obtain at least one wireless access network device group by grouping a plurality of wireless access network devices sending model subscription requests, the wireless access network device group including a first number of wireless access network devices. The determining module 102 is configured to determine a first number of model training structures corresponding to the first number of wireless access network devices, and determine a first number of unique model layers according to the first number of model training structures. The sending module 103 is configured to send, to the first number of wireless access network devices, structural parameters of the first number of unique model layers.

In an embodiment of the present disclosure, the determining module 102 is configured to: determine a first number of model subscription requests sent by the first number of wireless access network devices, and determine model training task characteristics of the first number of model subscription requests, the model training task characteristic being configured to indicate a number of layers and a number of nodes of a model; and determine the first number of model training structures according to the number of layers and the number of nodes of the model indicated by the model training task characteristics.

In an embodiment of the present disclosure, the determining module 102 is configured to: determine output layers of the first number of model training structures corresponding to the first number of wireless access network devices as the first number of unique model layers.

In an embodiment of the present disclosure, the determining module 102 is further configured to: determine input layers and hidden layers of the model training structures corresponding to the first number of radio access network devices as shared model layers, obtaining data of the plurality of radio access network devices, and adding, to the data, datum identifiers corresponding to respective radio access network devices; obtain model training data and model label values by classifying and processing all the data with the datum identifiers; obtain first output data output by the shared model layers by inputting the model training data as first input data to the shared model layers; and send the model label values and the first output data to the plurality of wireless access network devices.

In an embodiment of the present disclosure, the model training device further includes an updating module 104, configured to: update, in response to receiving training loss values from the plurality of wireless access network devices, structural parameters of the shared model layers according to the training loss values.

In an embodiment of the present disclosure, the updating module 104 is configured to: obtain weighted loss values by weighting the training loss values; determining current model parameters and current model learning rates of the shared model layers; and determining update parameters of the shared model layers according to the weighted loss values, the model parameters and the model learning rates, and updating the structural parameters of the shared model layers according to the update parameters.

In an embodiment of the present disclosure, the updating module 104 is configured to: determine, in response to a T^{th} update of the structural parameters of the shared model layers, that training of the shared model layers is complete, and send the model structural parameters of the shared model layers obtained after the T^{th} update, to each wireless access network device in the plurality of wireless access network device groups, wherein T is a predetermined number of times to update the shared model layers and the unique model layers, and the structural parameters of the shared model layers are configured for the wireless access network devices to synthesize a model to which the wireless access network device subscribes.

In an embodiment of the present disclosure, the grouping module 101 is configured to: determine a type of subscription model included in each of the model subscription requests; obtain a first number of model subscription request groups by grouping the model subscription requests according to the type of the subscription model; and obtain the first number of wireless access network device groups by grouping the wireless access network devices.

In an embodiment of the present disclosure, the updating module 104 is further configured to: in response to that there is a newly-joined wireless access network device and the newly-joined wireless access network device satisfies a model training condition, send the structural parameter of the unique model layer corresponding to the newly-joined wireless access network device to the newly-joined wireless access network device; or re-determine the first number of model training structures in response to that there is an exiting wireless access network device.

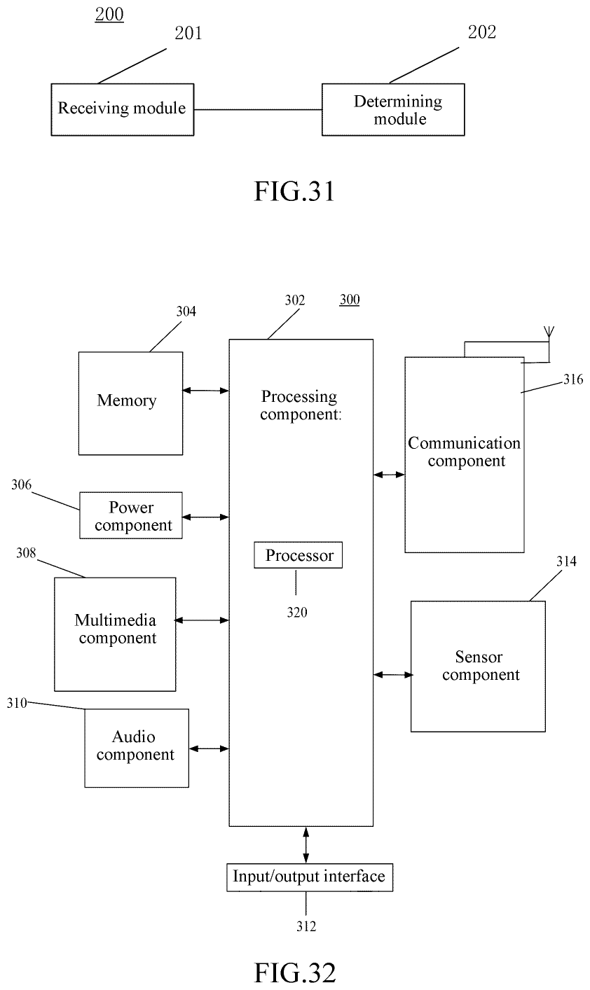

FIG. 31 is a block diagram of a model training device according to an embodiment. Referring to FIG. 31, the device 200 is applied to a wireless access network device and includes a receiving module 201.

The receiving module 201 is configured to receive a structural parameter of a unique model layer sent by an OAM. The unique model layer is determined by the OAM dividing a first number of model training structures, the first number of model training structures are determined by the OAM according to model subscription requests of a first number of wireless access network devices included in a wireless access network device group.

In an embodiment of the present disclosure, the receiving module 201 is further configured to: receive model label values and first output data sent by the OAM; obtain second output data output by the unique model layer by using the first output data as input to the unique model layer and inputting the first output data to the unique model layer; and determine a training loss value according to the model label value and the second output data, and send the training loss value to the OAM.

In an embodiment of the present disclosure, the model training device further includes a determining module 202, configured to: determine, among the model label values, the model label value corresponding to the wireless access network device according to identifiers carried by the model training data; and determine the training loss value by performing an operation on the second output data and the training label value, and updating the structural parameter of the unique model layer according to the training loss value.

In an embodiment of the present disclosure, the receiving module 201 is further configured to: receive a structural parameter of a shared model layer sent by the OAM; and determine a structural parameter of a subscription model according to the structural parameter of the shared model layer and the structural parameter of the unique model layer after a T^{th} update. T is a predetermined number of times to update the shared model layer and the unique model layer.

With respect to the device in the above embodiments, the specific manner in which each module performs an operation has been described in detail in the embodiments relating to the method, which will not be described in detail herein.

FIG. 32 is a block diagram of a device 300 for model training according to an embodiment. For example, the device 300 may be a mobile phone, a computer, a digital broadcasting terminal, a messaging device, a game console, a tablet device, a medical device, a fitness device, a personal digital assistant, or the like.

Referring to FIG. 32, the device 300 may include one or more of a processing component 302, a memory 304, a power component 306, a multimedia component 308, an audio component 310, an input/output (I/O) interface 312, a sensor component 314, and a communication component 316.

The processing component 302 generally controls the overall operations of the device 300, such as operations associated with display, telephone calls, data communications, camera operations, and recording operations. The processing component 302 may include one or more processors 320 to execute instructions to complete all or part of the steps of the foregoing method. In addition, the processing component 302 may include one or more modules to facilitate interaction between the processing component 302 and other components. For example, the processing component 302 may include a multimedia module to facilitate the interaction between the multimedia component 308 and the processing component 302.

The memory 304 is configured to store various types of data to support the operation at the device 300. Examples of these data include instructions for any application or method operating on the device 300, contact data, phone book data, messages, pictures, videos and the like. The memory 304 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 306 provides power to various components of the device 300. The power component 306 may include a power management system, one or more power supplies, and other components associated with generating, managing, and distributing power for the device 300.

The multimedia component 308 includes a screen that provides an output interface between the device 300 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 308 includes a front camera and/or a rear camera. When the device 300 is in an operation mode, such as a shooting mode or a video mode, the front camera and/or the rear camera can receive external multimedia data. Each front camera and rear camera may be a fixed optical lens system or have focal length and optical zoom capabilities.

The audio component 310 is configured to output and/or input audio signals. For example, the audio component 310 includes a microphone (MIC), and when the device 300 is in an operation mode, such as a call mode, a recording mode, and a voice recognition mode, the microphone is configured to receive an external audio signal. The received audio signal can be further stored in the memory 304 or sent via the communication component 316. In some embodiments, the audio component 310 further includes a speaker for outputting audio signals.

The I/O interface 312 provides an interface between the processing component 302 and a peripheral interface module. The above-mentioned peripheral interface module may be a keyboard, a click wheel, a button, and the like. These buttons may include but are not limited to home button, volume button, start button, and lock button.

The sensor component 314 includes one or more sensors for providing the device 300 with various aspects of state evaluation. For example, the sensor component 314 can detect the on/off status of the device 300 and the relative positioning of components. For example, the component is a display and keypad of the device 300. The sensor component 314 can also detect the position change of the device 300 or a component of the device 300, the presence or absence of contact between the user and the device 300, the orientation or acceleration/deceleration of the device 300, and the temperature change of the device 300. The sensor component 314 may include a proximity sensor configured to detect the presence of nearby objects when there is no physical contact. The sensor component 314 may also include a light sensor, such as a CMOS or CCD image sensor, for use in imaging applications. In some embodiments, the sensor component 314 may also include an acceleration sensor, a gyroscope sensor, a magnetic sensor, a pressure sensor, or a temperature sensor.

The communication component 316 is configured to facilitate wired or wireless communication between the device 300 and other devices. The device 300 can access a wireless network based on a communication standard, such as WiFi, 2G, or 3G, or a combination thereof. In an embodiment, the communication component 316 receives a broadcast signal or broadcast related information from an external broadcast management system via a broadcast channel. In an embodiment, the communication component 316 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the device 300 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 304 including instructions, and the instructions may be executed by the processor 320 of the device 300 to complete the foregoing method. For example, the non-transitory computer-readable storage medium may be ROM, random access memory (RAM), CD-ROM, magnetic tape, floppy disk, optical data storage device and the like.

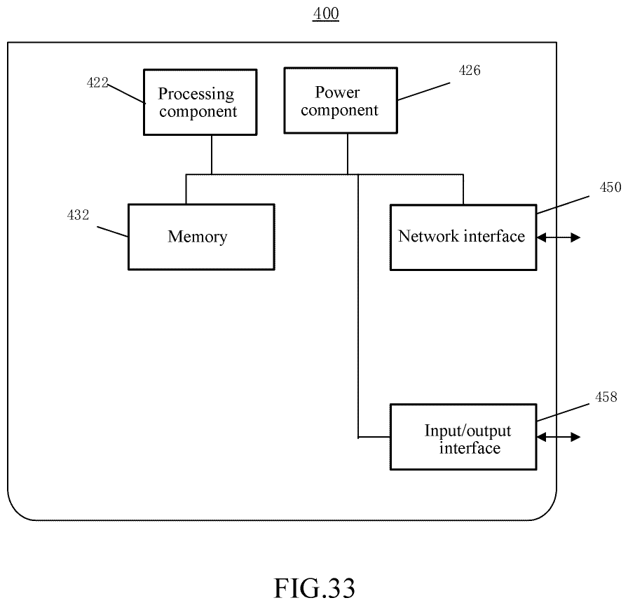

FIG. 33 is a block diagram of a device 400 for model training according to an embodiment. Referring to FIG. 33, the device 400 includes a processing component 422 which further includes one or more processors, and a memory resource which is represented by a memory 432 and is configured for storing instructions such as application programs executable by the processing component 422. The application program stored in the memory 432 may include one or more modules each corresponding to a set of instructions. Furthermore, the processing component 422 is configured to execute instructions to perform any of the above methods.

The device 400 may also include a power component 426 configured to perform power management of the device 400, a wired or wireless network interface 450 configured to connect the device 400 to a network, and an input/output (I/O) interface 458. The device 400 may operate based on an operating system stored in memory 432, such as Windows Server™, Mac OS X™, Unix™, Linux™, Free BSD™ or the like.

It is further understood that the term “plurality” in the present disclosure means two or more, and other quantifiers are similar. The term “and/or”, describing the association of associated objects, indicates that three relationships can exist, for example, A and/or B, which can indicate the presence of A alone, A and B together, and B alone. The character “/” generally indicates an “or” relationship between the preceding and following associated objects. The singular forms “a”, “said” and “the” are also intended to include plural forms, unless the context clearly indicates otherwise.

It is further understood that the terms “first”, “second” and the like are used to describe a variety of information, but that such information should not be limited to these terms. These terms are only used to distinguish information of the same type from one another and do not indicate a particular order or level of importance. In fact, the expressions “first” and “second” may be used interchangeably. For example, without departing from the scope of the present disclosure, first information may also be referred to as second information, and similarly, second information may also be referred to as first information.

It is further understood that although the operations are depicted in the accompanying drawings in a particular order in embodiments of the present disclosure, this should not be construed as requiring that the operations be performed in the particular order shown or in serial order, or that all of the operations shown be performed to obtain the desired results. Multitasking and parallel processing may be advantageous in particular environments.

Those skilled in the art may easily conceive of other embodiments of the present disclosure upon consideration of the specification and practice of the invention disclosed herein. The present disclosure is intended to cover any variations, uses, or adaptations of the present disclosure that follow the general principles of the present disclosure and include the common general knowledge or conventional technical means in the technical field not disclosed by the present disclosure. The specification and embodiments are to be regarded as exemplary only.

It is to be understood that the present disclosure is not limited to the precise structures described above and illustrated in the accompanying drawings, and that various modifications and changes may be made without departing from the scope thereof.

1. A model training method applied to an operation administration and maintenance (OAM) entity, comprising:
obtaining at least one wireless access network device group by grouping a plurality of wireless access network devices sending model subscription requests, the wireless access network device group comprising a first number of wireless access network devices;
determining a first number of model training structures corresponding to the first number of wireless access network devices, and determining a first number of unique model layers according to the first number of model training structures; and
sending, to the first number of wireless access network devices, structural parameters of the first number of unique model layers.

2. The model training method according to claim 1, wherein determining the first number of model training structures corresponding to the first number of wireless access network devices comprises:
determining a first number of model subscription requests sent by the first number of wireless access network devices, and determining model training task characteristics of the first number of model subscription requests, the model training task characteristic being configured to indicate a number of layers and a number of nodes of a model; and
determining the first number of model training structures according to the number of layers and the number of nodes of the model indicated by the model training task characteristics.

3. The model training method according to claim 1, wherein determining the first number of unique model layers according to the first number of model training structures comprises:
determining output layers of the first number of model training structures corresponding to the first number of wireless access network devices as the first number of unique model layers.

4. The model training method according to claim 1, further comprising:
determining input layers and hidden layers of the model training structures corresponding to the first number of radio access network devices as shared model layers, obtaining data of the plurality of radio access network devices, and adding, to the data, datum identifiers corresponding to respective radio access network devices;
obtaining model training data and model label values by classifying and processing all the data with the datum identifiers;
obtaining first output data output by the shared model layers by inputting the model training data as first input data to the shared model layers; and
sending the model label values and the first output data to the plurality of wireless access network devices.

5. The model training method according to claim 4, further comprising:
updating, in response to receiving training loss values from the plurality of wireless access network devices, structural parameters of the shared model layers according to the training loss values.

6. The model training method according to claim 5, wherein updating the shared model layers according to the training loss values comprises:
obtaining weighted loss values by weighting the training loss values;
determining current model parameters and current model learning rates of the shared model layers; and
determining update parameters of the shared model layers according to the weighted loss values, the model parameters and the model learning rates, and updating the structural parameters of the shared model layers according to the update parameters.

7. The model training method according to claim 6, further comprising, after updating the shared model layers according to the update parameters:
determining, in response to a T^{th} update of the structural parameters of the shared model layers, that training of the shared model layers is complete, and sending the model structural parameters of the shared model layers obtained after the T^{th} update, to each wireless access network device in the plurality of wireless access network device groups,
wherein T is a predetermined number of times to update the shared model layers and the unique model layers, and the structural parameters of the shared model layers are configured for the wireless access network devices to synthesize a model to which the wireless access network device subscribes.

8. The model training method according to claim 1, wherein obtaining the at least one wireless access network device group by grouping the plurality of wireless access network devices sending the model subscription requests comprises:
determining a type of subscription model included in each of the model subscription requests;
obtaining a first number of model subscription request groups by grouping the model subscription requests according to the type of the subscription model; and
obtaining the first number of wireless access network device groups by grouping the wireless access network devices.

9. The model training method according to claim 1, further comprising:
in response to that there is a newly-joined wireless access network device and the newly-joined wireless access network device satisfies a model training condition, sending the structural parameter of the unique model layer corresponding to the newly-joined wireless access network device to the newly-joined wireless access network device; or re-determining the first number of model training structures in response to that there is an exiting wireless access network device.

10. A model training method applied to a wireless access network device, comprising:
receiving a structural parameter of a unique model layer sent by an OAM,
wherein the unique model layer is determined by the OAM dividing a first number of model training structures, and the first number of model training structures are determined by the OAM according to model subscription requests of a first number of wireless access network devices comprised in a wireless access network device group.

11. The model training method according to claim 10, further comprising:
receiving model label values and first output data sent by the OAM;
obtaining second output data output by the unique model layer by using the first output data as input to the unique model layer and inputting the first output data to the unique model layer; and
determining a training loss value according to the model label value and the second output data, and sending the training loss value to the OAM.

12. The model training method according to claim 11, wherein determining the training loss value according to the model training data and the second output data comprises:
determining, among the model label values, the model label value corresponding to the wireless access network device according to identifiers carried by the model training data; and
determining the training loss value by performing an operation on the second output data and the training label value, and updating the structural parameter of the unique model layer according to the training loss value.

13. The model training method according to claim 10, further comprising:
receiving a structural parameter of a shared model layer sent by the OAM; and
determining a structural parameter of a subscription model according to the structural parameter of the shared model layer and the structural parameter of the unique model layer after a Tth update,
wherein T is a predetermined number of times to update the shared model layer and the unique model layer.

14.-15. (canceled)

16. A model training device applied to an operation administration and maintenance (OAM) entity, comprising:
a processor; and
a memory for storing instructions that are executable by the processor,
wherein the instructions, when being executed by the processor, causes the processor to implement:
obtaining at least one wireless access network device group by grouping a plurality of wireless access network devices sending model subscription requests, the wireless access network device group comprising a first number of wireless access network devices;
determining a first number of model training structures corresponding to the first number of wireless access network devices, and determining a first number of unique model layers according to the first number of model training structures; and
sending, to the first number of wireless access network devices, structural parameters of the first number of unique model layers.

17. (canceled)

18. The model training device according to claim 16, wherein determining the first number of model training structures corresponding to the first number of wireless access network devices comprises:
determining a first number of model subscription requests sent by the first number of wireless access network devices, and determining model training task characteristics of the first number of model subscription requests, the model training task characteristic being configured to indicate a number of layers and a number of nodes of a model; and
determining the first number of model training structures according to the number of layers and the number of nodes of the model indicated by the model training task characteristics.

19. The model training device according to claim 16, wherein determining the first number of unique model layers according to the first number of model training structures comprises:
determining output layers of the first number of model training structures corresponding to the first number of wireless access network devices as the first number of unique model layers.

20. The model training device according to claim 16, wherein the processor is caused to further implement:
determining input layers and hidden layers of the model training structures corresponding to the first number of radio access network devices as shared model layers, obtaining data of the plurality of radio access network devices, and adding, to the data, datum identifiers corresponding to respective radio access network devices;
obtaining model training data and model label values by classifying and processing all the data with the datum identifiers;
obtaining first output data output by the shared model layers by inputting the model training data as first input data to the shared model layers; and
sending the model label values and the first output data to the plurality of wireless access network devices.

21. The model training device according to claim 20, wherein the processor is caused to further implement:
updating, in response to receiving training loss values from the plurality of wireless access network devices, structural parameters of the shared model layers according to the training loss values.

22. The model training device according to claim 21, wherein updating the shared model layers according to the training loss values comprises:
obtaining weighted loss values by weighting the training loss values;
determining current model parameters and current model learning rates of the shared model layers; and
determining update parameters of the shared model layers according to the weighted loss values, the model parameters and the model learning rates, and updating the structural parameters of the shared model layers according to the update parameters.

23. The model training device according to claim 22, wherein the processor is caused to further implement, after updating the shared model layers according to the update parameters:
determining, in response to a T^{th} update of the structural parameters of the shared model layers, that training of the shared model layers is complete, and sending the model structural parameters of the shared model layers obtained after the T^{th} update, to each wireless access network device in the plurality of wireless access network device groups,
wherein T is a predetermined number of times to update the shared model layers and the unique model layers, and the structural parameters of the shared model layers are configured for the wireless access network devices to synthesize a model to which the wireless access network device subscribes.
